(19) United States
(12) Patent Application Publication
(10) Pub. No.: US 2016/0326200 A1
(43) Pub. Date: Nov. 10, 2016

(54) PRODRUG FOR RELEASE OF CISPLATIN AND CYCLOOXYGENASE INHIBITOR

(71) Applicant: UNIVERSITY OF GEORGIA RESEARCH FOUNDATION, INC., Athens, GA (US)

(72) Inventors: Shanta Dhar, Athens, GA (US); Rakesh Pathak, Columbus, OH (US)

(21) Appl. No.: 15/102,700

(22) PCT Filed: Dec. 12, 2014
(86) PCT No.: PCT/US2014/069997

§ 371 Date: Jun. 8, 2016

Related U.S. Application Data
(60) Provisional application No. 61/915,110, filed on Dec. 12, 2013.
(60) Provisional application No. 61/976,559, filed on Apr. 8, 2014.

(51) Int. Cl. C07F 15/00

(52) U.S. Cl. CPC C07F 15/0093

(57) ABSTRACT

Pt(IV) prodrugs include one or more conjugated cyclooxygenase inhibitor. Reduction of Pt(IV) to Pt(II) can result cisplatin and a cyclooxygenase inhibitor. For proof of concept, a Pt(IV) prodrug that can produce cisplatin and aspirin, Platin-A, was synthesized. Platin-A exhibited excellent anticancer and anti-inflammatory properties, which were better than the combination of free formulation of cisplatin and aspirin.

### RELATED APPLICATION

This application claims the benefit of U.S. Provisional Patent Application No. 61/915,110, filed Dec. 12, 2013, which application is hereby incorporated herein by reference in its entirety to the extent that it does not conflict with the disclosure presented herein.

### STATEMENT OF GOVERNMENTAL SUPPORT

This invention was made with government support under grant number W81XWH-12-1-0406, awarded by the Department of Defense of the United States government. The government has certain rights in the invention.

### FIELD

The present disclosure relates to prodrugs configured to release cisplatin and a cyclooxygenase inhibitor following administration to a subject; and methods of treating cancer associated therewith.

### BACKGROUND AND INTRODUCTION

Chronic inflammation plays an important role in approximately 20% of human cancers. Prostate cancer (PCa) is the most frequently diagnosed cancer and the second leading cause of cancer death in men in the United States. Patients with PCa inevitably progress to hormone-independent disease. PCa that progresses in the presence of androgen blockade is defined as Castration-Resistant Prostate Cancer (CRPC). A complex immune-mediated process and inflammation play crucial roles in PCa progression in the castrate setting and cancer-associated inflammation functionally plays an important role in the formation of metastasis.

Cis-diamminedichloroplatinum(II) or cisplatin is currently one of the most effective anticancer drugs available for treating a variety of solid tumors. Resistance to apoptotic death is a characteristic feature of advanced PCa and is one of the reasons for the failure of cisplatin-based therapeutic strategy of hormone refractory disease.

Nonsteroidal anti-inflammatory drugs (NSAIDs) can be an attractive additive to chemotherapeutic approaches for PCa due to their ostensive potential in cancer chemoprevention. The primary target of NSAIDs is cyclooxygenase (COX) isoforms, COX-1 and COX-2 that catalyze the rate-limiting step in the formation of prostaglandins (PGs). PGs are the group of lipid molecules derived from arachidonic acid and play a key role to generate inflammatory response. The inducible isoform COX-2 and its products, especially PGE2, are involved in inflammatory responses, inhibition of apoptosis, and induction of resistance. Increased levels of PGE and COX-2 mRNA are overexpressed in 83% of human PCa samples.

The use of cisplatin is limited for its side effects such as nephrotoxicity and ototoxicity. Nephrotoxicity can be reduced using saline hydration; however, there are no protective modalities for cisplatin ototoxicity. Acetylsalicylic acid or aspirin which is known to inhibit COX-1 and COX-2 irreversibly through trans-esterification between acetylsalicylic acid and Ser-530 residue of COX also has the potential to reduce severity of cisplatin-induced side effects related to hearing, balance, and kidney. Aspirin and its metabolite salicylate induce several anti-inflammatory cytokines to reduce inflammation. A combination of cisplatin and aspirin can be an attractive strategy to manage highly aggressive PCa.

Beneficial effects of combination of cisplatin and aspirin mixture were investigated to some extent. However, many challenges exist when studying drug combinations. Major obstacles in administering free drug formulations include: the choice of ratio of two drugs, the definitive delivery of the correct drug ratio, exposure to the targets of interest, and individual pharmacokinetics and biodistribution parameters.

### SUMMARY

The present disclosure describes, among other things, Pt(IV) prodrugs that produce Pt(II) cisplatin and one or more cyclooxygenase inhibitor upon reduction of Pt(IV) to Pt(II). A single prodrug containing a drug combination can potentially overcome some of the challenges discussed above.

In various embodiments described herein, a Pt(IV) prodrug can be used to, among other things, ameliorate the nephrotoxicity caused by cisplatin due to the anti-inflammatory properties of a cyclooxygenase inhibitor. In studies described herein, Platin-A, which is a Pt(IV) prodrug that can produce cisplatin and aspirin upon reduction of the Pt, exhibited excellent anticancer and anti-inflammatory properties. The results obtained with Platin-A were better than the combination of formulations of free cisplatin and aspirin.

The Pt(IV) prodrugs described herein can include one or more cyclooxygenase inhibitors directly bound to Pt(IV) or bound to Pt(IV) via a linker. Readily available chemistry techniques such as click chemistry can be used to synthesize Pt(IV) prodrugs as described herein where one or more cyclooxygenase inhibitor is bound to Pt(IV) via a linker.

In various embodiments described herein, a compound, which may be a prodrug, has a structure as follows:

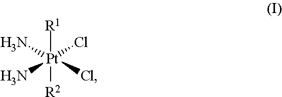

where
R¹ is -(L¹)ₘ-(R³)ₙ;
R² is OH or -(L²)ₓ-(R⁴)_{y};
R³ is a conjugated cyclooxygenase inhibitor;
R⁴ is a conjugated cyclooxygenase inhibitor or a targeting moiety, wherein if R⁴ is a conjugated cyclooxygenase inhibitor, R³ and R⁴ are the same or different;
L¹ is a linker;
L² is a linker, wherein L¹ and L², if both are present, are the same or different;
m and x are independently zero or one; and
n and y are independently an integer greater than or equal to 1.

In some embodiments, when m=0, n=1 and when x=0, y=1.

In some embodiments, n and y of Formula I are an integer from 1 to 8, such as an integer from 1 to 4. The linkers, L¹ and L², if employed, can be selected to control the number of moieties of R³ and R⁴ present in the compound of Formula I. That is, the linkers, L¹ and L², can determine the value of n and y. In various embodiments, R⁴ of Formula I is a cyclooxygenase inhibitor.

Reduction of the Pt(IV) of a compound according Formula I to Pt(II) produces cisplatin, R¹H and R²H. When m=0 and n=1, R¹H is R³H, and R³H is a cyclooxygenase (COX) inhibitor. When x=0 and y=1, R²H is R⁴H and R⁴H is water, a COX inhibitor, a reduced cell targeting moiety, or the like. In various embodiments, R⁴H is a COX inhibitor.

In some embodiments, one or both of R³H and R⁴H are aspirin.

A compound according to Formula I can be used for treating cancer, such as prostate cancer, in a subject in need thereof. A compound according to Formula I can alternatively or additionally be used to treat an inflammatory disease in a subject in need thereof.

Advantages of one or more of the various embodiments presented herein over prior combination therapies including cisplatin and a cyclooxygenase inhibitor will be readily apparent to those of skill in the art based on the following detailed description when read in conjunction with the accompanying drawings.

### BRIEF DESCRIPTION OF THE DRAWINGS

FIG. 1 is a schematic drawing illustrating an embodiment of a reaction scheme for synthesizing a compound in accordance with an embodiment described herein.

FIG. 2: 1H and 13C NMR of ‘Platin-A’ in DMSO-d6.

FIG. 3: 195Pt NMR spectrum of Platin-A in DMSO-d6.

FIG. 4: Positive ion ESI-HRMS spectrum of ‘Platin-A’ and isotopic peak pattern analysis.

FIG. 5 is a schematic drawing illustrating the structure of a compound in accordance with an embodiment described herein, Platin-A, and an embodiment of its mechanisms of action.

FIG. 6: Cyclic voltammograms of ‘Platin-A’ in 1:4 dimethyformamide (DMF)-phosphate buffer-0.1 M KCl at two different pH values. Top graph shows the cyclic voltammograms of ‘Platin-A’ with varied scan rates at pH 7.4. Bottom graph shows the cyclic voltammograms of ‘Platin-A’ with varied scan rates at pH 6.4.

FIG. 7: MALDI-TOF MS chromatogram of Pt-GG adduct obtained by the reaction of Platin-A and 5″-GMP in presence of sodium ascorbate. Exhibited isotopic peak pattern confirms the presence of Pt species in Pt-GG adduct.

FIG. 8: HPLC analysis on the reaction products of Platin-A and sodium ascorbate. Pure aspirin and salicylic acid were used for comparison. Wavelength used: 280 nm.

FIG. 9: (A) Representative cytotoxic profiles of Platin-A in PCa cell lines and comparison of activities with cisplatin and an equimolar mixture of cisplatin and aspirin. (B) Apoptosis inducing property of Platin-A by annexin V-FITC/PI staining of PC3 cells. Four distinct phenotypes: viable cells (lower left quadrant); cells at early stage of apoptosis (lower right quadrant); cells at late stage of apoptosis or necrosis (upper right quadrant); debris (upper left quadrant).

FIG. 10: PC3 cells (1×10⁶ cells/mL) on day 2 were treated with etoposide (100 μM, 12 h) and H₂O₂ (1 mM, 45 min) as positive controls of apoptosis and necrosis and analyzed by annexin V-FITC/PI staining. Four distinct phenotypes: viable cells (lower left quadrant); cells at early stage of apoptosis (lower right quadrant); cells at late stage of apoptosis or necrosis (upper right quadrant); debris (upper left quadrant).

FIG. 11: Ability of Platin-A to inhibit ovine COX-1 and COX-2 using EIA.

FIG. 12: COX inhibitory properties of Platin-A at different concentrations and comparison with aspirin using an enzyme immunoassay (EIA).

FIG. 13: Immunofluorescence analysis of COX-2 expressions in PC3 cells. (A) COX-2 expressions in PC3 cells and the effect of aspirin (1 μM), and an equimolar ratio of cisplatin and aspirin (1 μM each), and Platin-A (1 μM) (B) effect on the COX-2 levels in PC3 cells upon treatment with TNF-α, and the effect of aspirin (1 μM), and an equimolar ratio of cisplatin and aspirin (1 μM each), and Platin-A (1 μM) on TNF-α stimulated cells. Cells were DAPI-stained in blue. COX-2 were labeled with a primary rabbit polyclonal antibody and subsequently labeled with a secondary AlexaFluor 488 goat anti-rabbit antibody. All scale bars are 25 μm.

FIG. 14: Quantification of COX-2 inhibition in PC3 cells by aspirin (1 μM), an equimolar ratio of cisplatin and aspirin (1 μM each), and Platin-A (1 μM) (left). Expression levels of COX-2 after treatment with TNF-α (right) and subsequent treatment with aspirin (1 μM), an equimolar ratio of cisplatin and aspirin (1 μM each), and Platin-A (1 μM) (right). COX-2 was labeled with a primary rabbit polyclonal antibody and subsequently labeled with a secondary Alexa Fluor® 488 goat anti-rabbit antibody. Data were recorded on a plate reader with an emission wavelength of 488 nm and an excitation wavelength of 519 nm. Statistical analyses were performed by using one-way ANOVA with Tukey pos hoc test.

FIG. 15: Anti-inflammatory properties of Platin-A. (A) RAW 264.7 macrophages were treated with LPS to induce inflammation and the effects of cisplatin, aspirin, an equimolar mixture of cisplatin and aspirin, and Platin-A on the levels of IL-6, TNF-α, and IL-10 were studied using ELISA. (B) RAW 264.7 macrophages were treated with cisplatin, aspirin, an equimolar mixture of cisplatin and aspirin, and Platin-A followed by addition of LPS and preventive action of the test articles on the levels of IL-6, TNF-α, and IL-10 were studied using ELISA. Statistical analyses were performed by using one-way ANOVA with Tukey post hoc test.

FIG. 16: Cytotoxicity of Platin-A (10 μM), cisplatin (10 μM), aspirin (10 μM), and cisplatin (10 μM)+aspirin (10 μM) on LPS activated RAW 264.7 macrophages with incubation time of 24 h.

FIG. 17: Mechanism of action of Platin-A in tumor microenvironment.

The schematic drawings in are not necessarily to scale. Like numbers used in the figures refer to like components, steps and the like. However, it will be understood that the use of a number to refer to a component in a given figure is not intended to limit the component in another figure labeled with the same number. In addition, the use of different numbers to refer to components is not intended to indicate that the different numbered components cannot be the same or similar.

### DETAILED DESCRIPTION

In the following detailed description, reference is made to the accompanying drawings that form a part hereof, and in which are shown by way of illustration several specific embodiments of devices, systems and methods. It is to be understood that other embodiments are contemplated and may be made without departing from the scope or spirit of the present disclosure. The following detailed description, therefore, is not to be taken in a limiting sense.

The present disclosure describes, among other things, Pt(IV) prodrugs that produce Pt(II) cisplatin and one or more cyclooxygenase inhibitor upon reduction of Pt(IV) to Pt(II). The Pt(IV) prodrugs described herein can include one or more cyclooxygenase inhibitors directly bound to Pt(IV) or bound to Pt(IV) via a linker. Readily available chemistry techniques such as click chemistry can be used to synthesize Pt(IV) prodrugs as described herein where one or more cyclooxygenase inhibitor is bound to Pt(IV) via a linker.

In various embodiments described herein, a compound, which may be a prodrug, has a structure as follows:

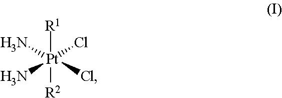

where
R¹ is -(L¹)ₘ-(R³)ₙ;
R² is OH or -(L²)ₓ-(R⁴)_{y};
R³ is a conjugated cyclooxygenase inhibitor;
R⁴ is a conjugated cyclooxygenase inhibitor or a targeting moiety, wherein if R⁴ is a conjugated cyclooxygenase inhibitor, R³ and R⁴ are the same or different;
L¹ is a linker;
L² is a linker, wherein L¹ and L² are the same or different;
m and x are independently zero or one; and
n and y are independently an integer greater than or equal to 1.

In some embodiments, when m=0, n=1 and when x=0, y=1.

In some embodiments, n and y of Formula I are an integer from 1 to 8, such as an integer from 1 to 4. The linkers, L¹ and L², if employed, can be selected to control the number of moieties of R³ and R⁴ present in the compound of Formula I. That is, the linkers, L¹ and L², can determine the value of n and y.

Click chemistry can be employed to conjugate a linker or a linker to which one or more cyclooxygenase inhibitors, targeting moieties, or the like are attached to a Pt(IV) compound.

Examples of suitable click chemistry techniques include copper-catalyzed azide-alkyne cycloaddition (CuAAC), strain promoted alkyne cycloaddition (SPAAC) and the like. Azide functionality can readily be added to an Pt(IV) compound, such as c,c,t [PtCl₂(NH₃)₂(OH)₂], by reacting the Pt(IV) compound with a azide anhydride as, for example, shown below:

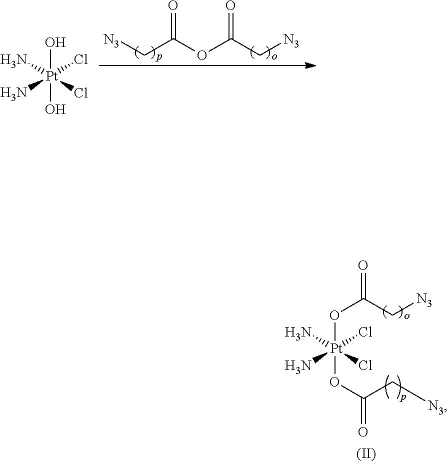

where o and p are independently 0 to 10, such as 3 to 7 or, for example, 5. In some embodiments, o and p are the same. In some embodiments the azide anhydride is 6-azidohexanoic anhydride. In some embodiments, only one azide moiety is added to the resulting Pt compound by limiting the concentration of the azide anhydride or blocking one of the hydroxyl groups. Any suitable solvent can be used. Examples of suitable solvents include dimethyl sulfoxide (DMSO), dimethyl formamide (DMF), and the like. c,c,t [PtCl₂(NH₃)₂(OH)₂] can be synthesized in any suitable manner, such as reacting Cisdiamminedichloridoplatinum(II) (cisplatin) with hydrogen peroxide.

An azide functionalized Pt(IV) compound, such as a compound according to Formula II as described above, can then be reacted with an alkyne-containing linker, which can optionally contain one or more conjugated cyclooxygenase inhibitors, targeting moieties, or the like. If the alkyne-containing linker does not contain, for example, one or more conjugated cyclooxygenase inhibitors or targeting moieties, such moieties can be conjugated to the linker after the linker is reacted with the azide-functionalized Pt(IV) compound.

As indicated above, CuAAC, SPAAC, or any other suitable form of click chemistry can be employed. Examples of SPAAC alkyne-containing compounds that can include or can be modified to include a cyclooxygenase inhibitor, a targeting moiety, or the like are described in, for example, U.S. Pat. No. 8,133,515, entitled ALKYNES AND METHODS OF REACTING ALKYNES WITH 1,3-DIPOLE-FUNCTIONAL COMPOUNDS, and U.S. Provisional Patent Application No. 61/947,703, filed Mar. 4, 2014, entitled STRAIN PROMOTED AZIDE ALKYNE CYCLOADDITION REACTION ON PT(IV) SCAFFOLD: A VERSATILE BIOORTHOGONAL APPROACH TO FUNCTIONALIZE CISPLATIN PRODRUGS, which patent and patent application are each hereby incorporated herein by reference in their respective entireties to the extent that they do not conflict with the present disclosure.

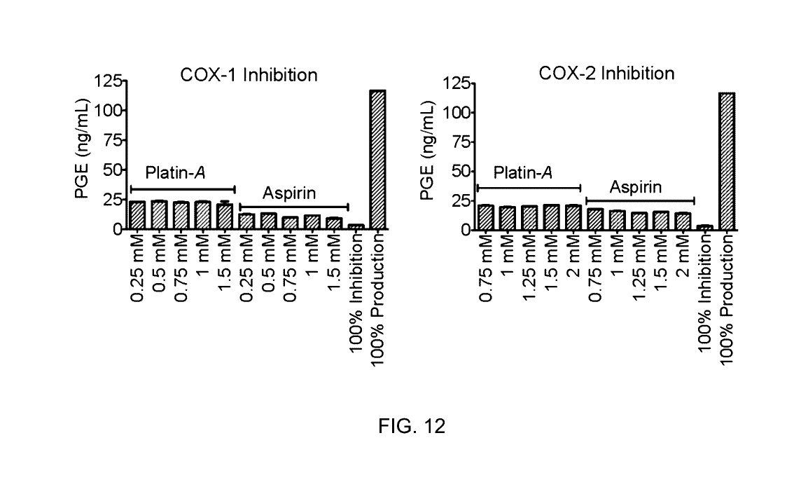

For purposes of illustration, SPAAC reaction of functionalized azadibenzocyclooctyne (ADIBO) derivatives with an azide functionalized Pt(IV) compound according to Formula II is shown below.

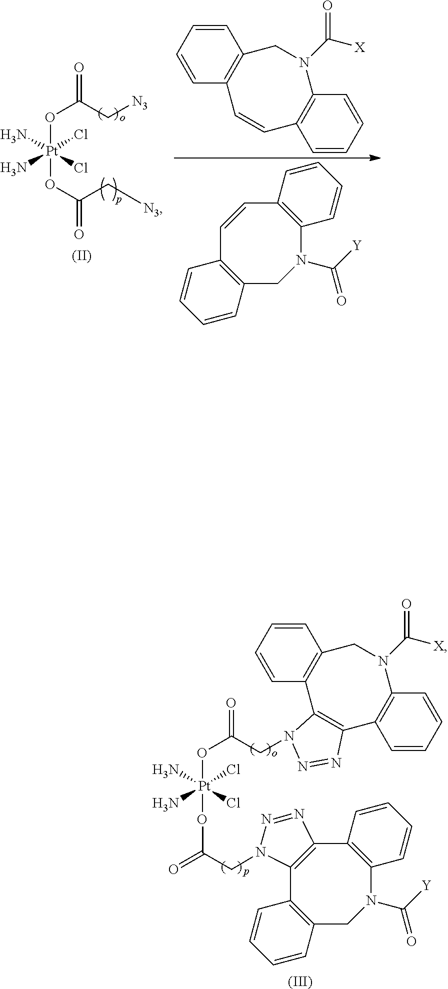

where o and p are as defined above with regard to a compound according to Formula II, where X is R³ or -linker-R³ or a functional group to which R³ or -linker-R³ can be conjugated, and where Y is R⁴ or -linker-R⁴ or a functional group to which R³ or -linker-R³ can be conjugated. R³ and R⁴ are as defined above with regard to a compound according to Formula I. The linker of X and Y, if present, can independently be any suitable linker to which R³ or R⁴ can be bound. In some embodiments, the linker comprises a cleavable linker. A cleavable linker can provide controllable release of, for example, a cyclooxygenase inhibitor (e.g. R³ or R⁴, when R⁴ is a cyclooxygenase inhibitor). Any suitable cleavable linker can be employed. Examples of suitable cleavable linkers include those presented in FIG. 12 of U.S. Pat. No. 8,133,515, such as disulfide linkers, oxime linkers, hydrazine linkers, diazo linkers, carbonyloxyethylsulfone linkers, amino acid linkers, phenylacetamide linkers, and the like. The linker can be chosen to facilitate release of R³ or R⁴, as the case may be, in an environment that is expected at a target location of a subject to which a compound according to Formula I is administered. In some embodiments, a cyclooxygenase inhibitor will be released by esterased or acid base catalyzed reactions in cellular/tumor milieu when embodiments of compound according to Formula I are administered to a subjects having cancer. Cancer cells are often characterized with up-regulation of cellular esterases and their tumor microenvironment becomes acidic. Accordingly, esterased or acid base catalyzed release of a cyclooxygenase can be selectively released in the microenvironment of tumor or inside the tumor cells. Therefore, premature release of the cyclooxygenase can be minimal.

For purposes of further illustration, a CuAAC click chemistry reaction of an azide functionalized Pt(IV) compound according to Formula II with an alkyne-containing compound that can serve as a linker to which more than one R³, R⁴, -linker-R³, or -linker-R⁴ moiety (e.g., as described above) can be conjugated is shown below.

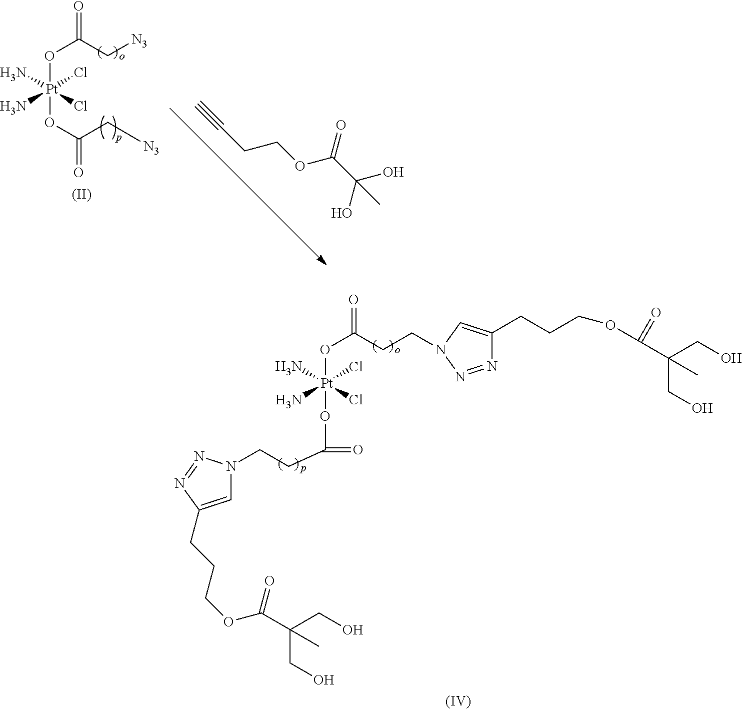

where o and p are as defined above with regard to a compound according to Formula II. The reaction can take place in the presence of a copper catalyst, such as CuI. An R³, R⁴, -linker-R³, or -linker-R⁴ moiety can be conjugated to an oxygen of a hydroxyl group of the compound according to Formula IV in any suitable manner, such as by a condensation reaction. In some embodiments, R³, R⁴, -linker-R³, or -linker-R⁴ moieties are conjugated to the alkyne-functionalized linker prior to the CuAAC reaction, which can allow incorporation of different R³, R⁴, -linker-R³, or -linker-R⁴ moieties in the resulting compound.

For purposes of example, a Pt(IV) compound containing four aspirin moieties in accordance with the teachings presented herein is shown below.

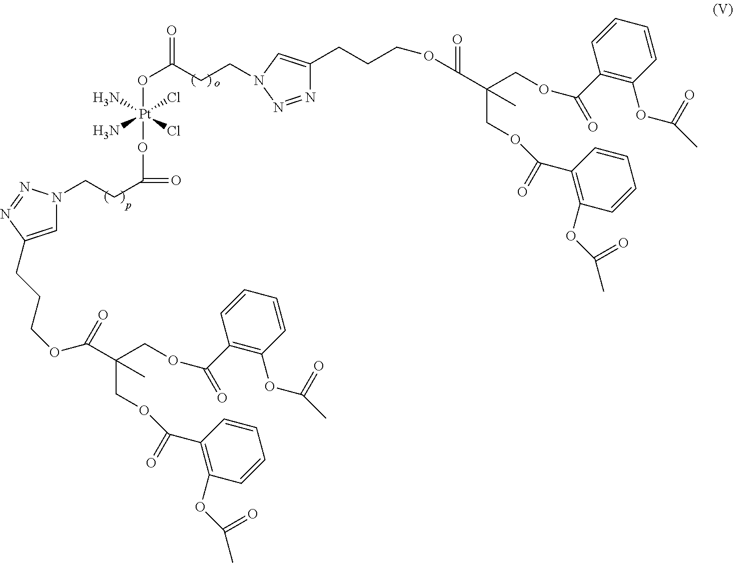

where o and p are as defined above with regard to a compound according to Formula II.

For purposes of example, a Pt(IV) compound containing eight aspirin moieties in accordance with the teachings presented herein is shown below.

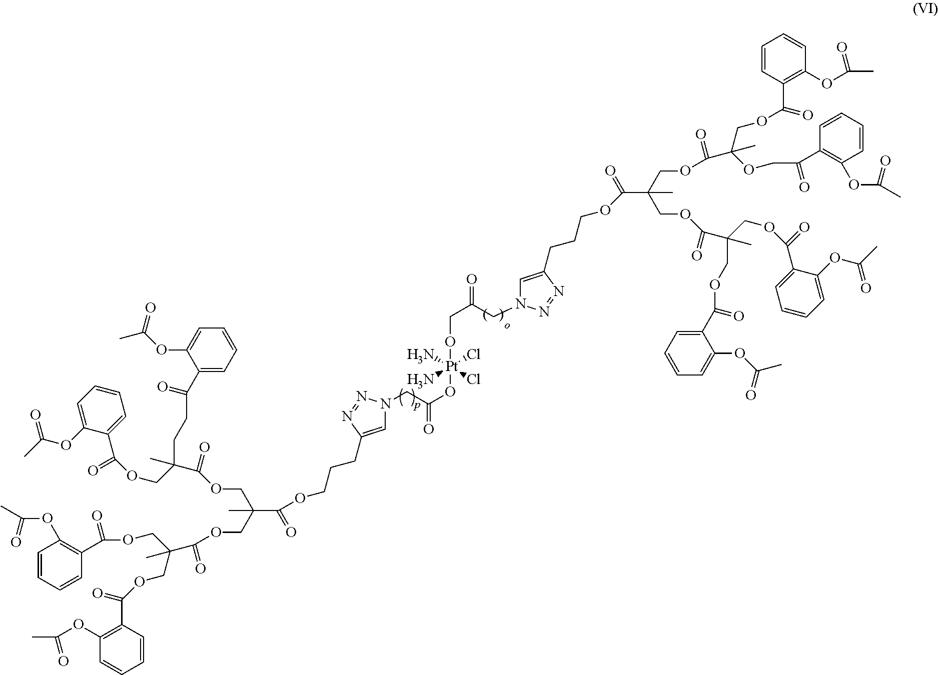

where o and p are as defined above with regard to a compound according to Formula II.

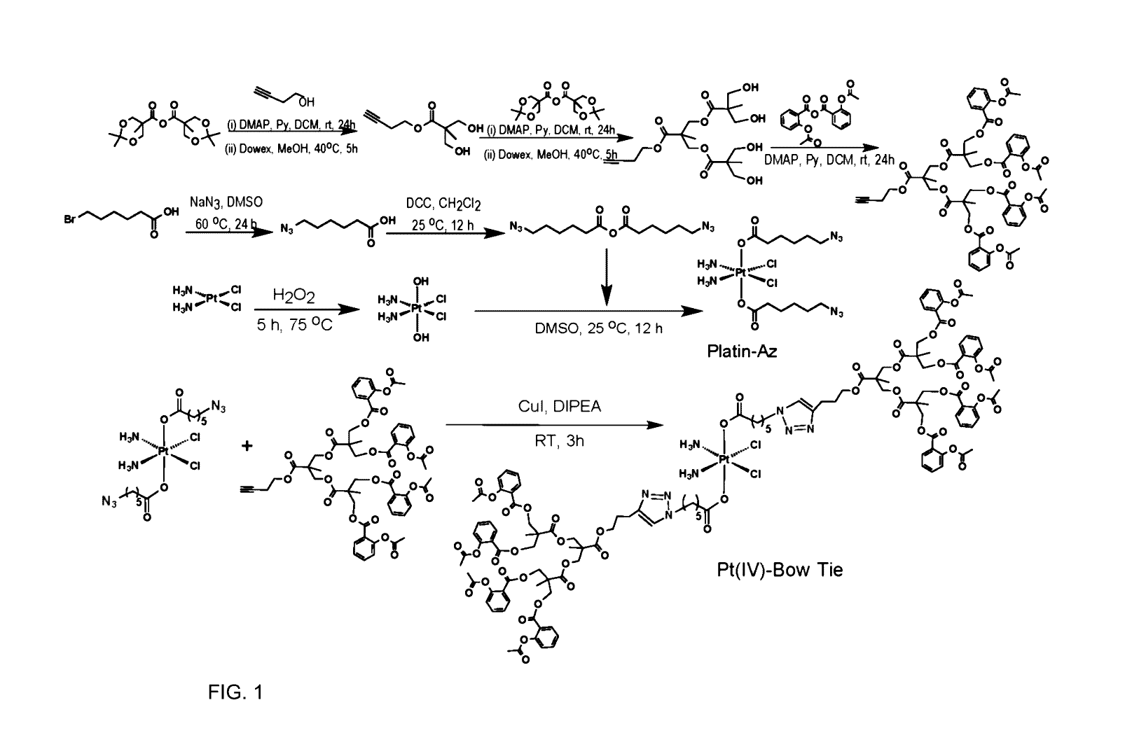

A reaction scheme for synthesis of a compound according to Formula VI is depicted in FIG. 1, where “Platin-Az” is a compound according to Formula II where o is 5 and p is 5 and where “Pt(IV)-Bow Tie” is a compound according to Formula VI where o is 5 and p is 5.

Aspirin should be released from compounds according to Formulas V and VI by esterased or acid base catalyzed reactions in cellular/tumor milieu when administered to a subject having cancer. Cancer cells are often characterized with up-regulation of cellular esterases and their tumor microenvironment becomes acidic. Accordingly, esterased or acid base catalyzed release of a cyclooxygenase can be selectively released in the microenvironment of tumor or inside the tumor cells. Therefore, premature release of the cyclooxygenase can be minimal. Additionally, we hypothesized that first an entire Dendron bearing two or four aspirin, in the case of a compound according to Formula V or VI, will be detached from Pt(IV) species while it converts to the Pt(II) form. This dendron can slowly release the aspirin in spatiotemporal fashion in the inflamed tumor tissue surroundings to reduce the cancer associated inflammation.

In various embodiments, a compound according to Formula I is a compound where m is zero and n is 1, such that R¹ is R³, which is a conjugated cyclo-oxygenase inhibitor. For purposes of illustration, a compound according to Formula I, where R¹ is conjugated aspirin and R² is OH is shown below:

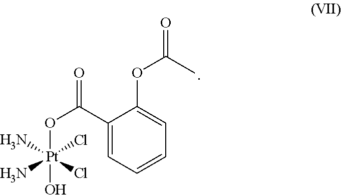

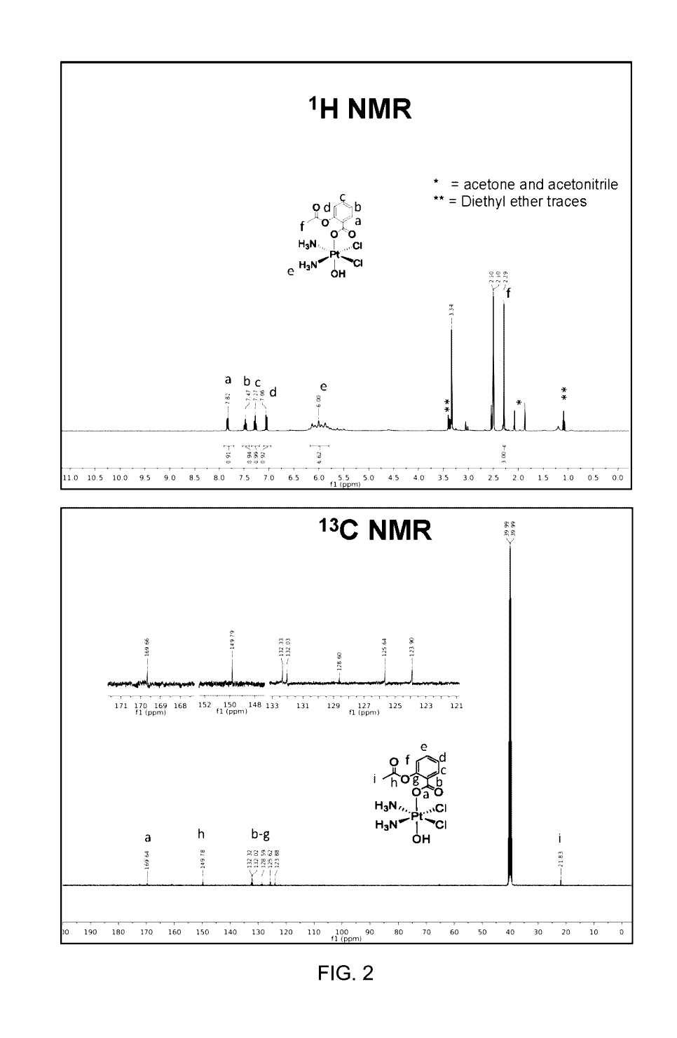

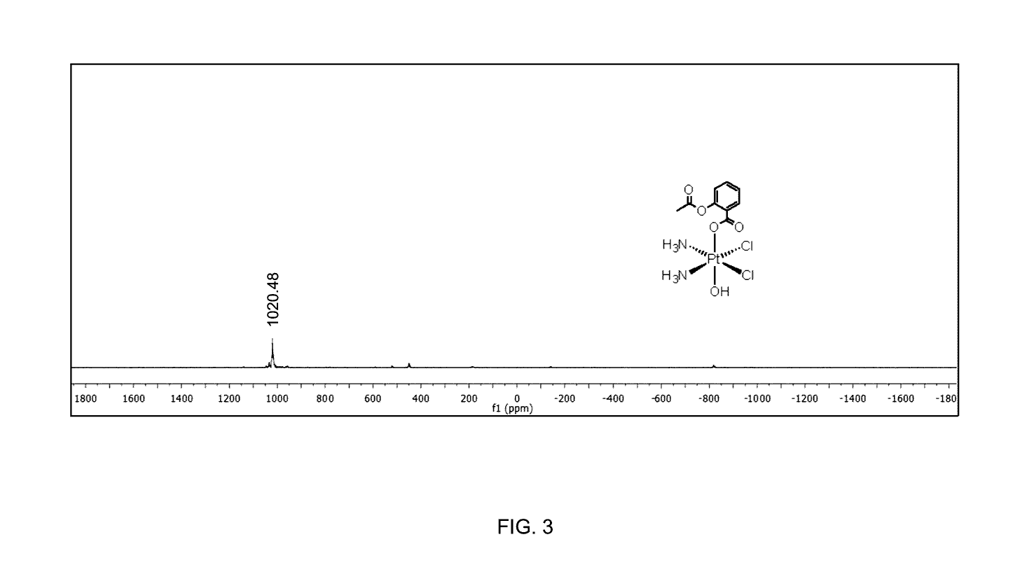

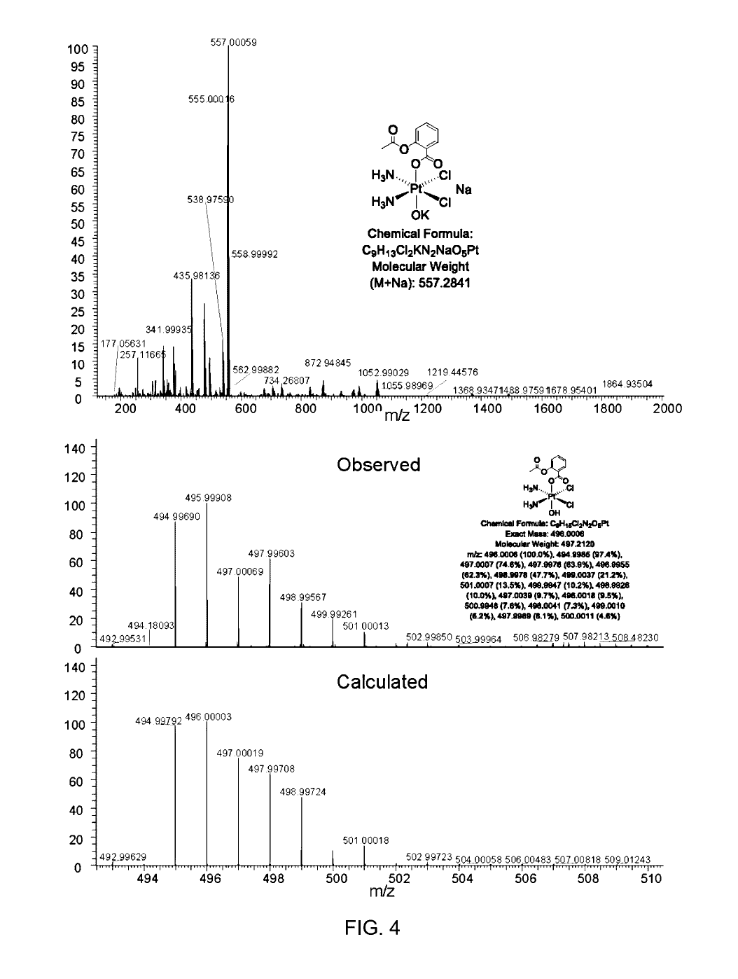

The compound according to Formula (VII) is sometimes referred to herein as “Platin-A.” Embodiments of reactions for synthesizing Platin-A are described in more detail below. Briefly, Platin-A was synthesized by reacting c,c,t-[Pt(NH₃)₂Cl₂(OH)₂] with aspirin anhydride. In order to get one aspirin on to the cisplatin platform, a diluted reaction medium was used. Platin-A was characterized using several spectroscopic and analytical techniques (FIGS. 2-4).

For purposes of further illustration, a compound according to Formula I, where R¹ is conjugated salicylic acid and R² is OH is shown below:

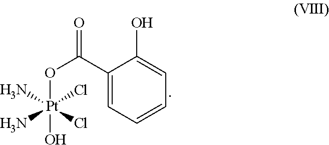

It will be understood that the specific compounds and reaction schemes described above are presented for purposes of illustrating that a large variety of compounds according to Formula I can be made according to a variety of reaction schemes and are not presented for purposes of limitation.

A general scheme showing R¹H, R²H and cisplatin resulting from reduction of Pt(IV) of Formula I to Pt (II) is provided below:

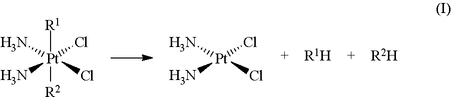

If R¹ is R³, which is a conjugated cyclooxygenase inhibitor, reduction of the Pt results in release of the cyclooxygenase inhibitor R³H. If R¹ contains a linker, L¹, as described above (e.g., m is 1), one or more R³ moiety can, in some instances, be released (e.g, via cleavage of a cleavable linker, hydrolysis, etc.) prior to reduction of the Pt and release of the remaining portion of R¹. Similarly, if R² is OH or R⁴, reduction of the Pt results in release water or R⁴H, which as discussed above can be a cyclooxygenase inhibitor, targeting moiety or the like. If R² contains a linker, L², as described above (e.g., x is 1), one or more R⁴ moiety can, in some instances, be released (e.g, via cleavage of a cleavable linker, hydrolysis, etc.) prior to reduction of the Pt and release of the remaining portion of R².

R³, and optionally R⁴, of a compound according to Formula I can be any suitable conjugated cyclooxygenase inhibitor. In some embodiments, the cyclooxygenase inhibitor is a nonsteroidal anti-inflammatory drug (NSAID). Examples of suitable NSAIDS include aspirin, salicylates (e.g., sodium, magnesium, choline), celecoxib, diclofenac potassium, diclofenac sodium, diflunisal, etodolac, fenoprofen calcium, flurbiprofen, ibuprofen, indomethacin, ketoprofen, meclofenamate sodium, mefenamic acid, meloxicam, nabumetone, naproxen, naproxen sodium, oxaprozin, piroxicam, rofecoxib, salsalate, sulindac, tolmetin sodium, valdecoxib, and the like. In some embodiments, a compound according to Formula I includes one of more of the following conjugated cyclooxygenase inhibitors, which are releasable in a pharmaceutically active form: aspirin (acetyl salicylic acid); salicylic acid; Sulindac Sulfone ((Z)-5-Fluoro-2-methyl-1 [p-(methylsulfonyl) benzylidene]indene-3-acetic Acid); Sulindac Sulfide ((Z)-5-Fluoro-2-methyl-1-[p-(methylthio)benzylidene]indene-3-acetic Acid); SC-560 (5-(4-Chlorophenyl)-1-(4-methoxyphenyl)-3-trifluoromethylpyrazole); Resveratrol (trans-3,4,5-Trihydroxystilbene); Pterostilbene succinate, ((E)-4-(4-(3,5-dimethoxystyryl)phenoxy)-4-oxobutanoic acid); Meloxicam (4-((2-methyl-3-((5-methylthiazol-2-yl)carbamoyl)-1,1-dioxido-2H-benzo[e][1,2]thiazin-4-yl)oxy)-4-oxobutanoic acid); Indomethacin Ester, 4-Methoxyphenyl-(1-(p-Chlorobenzoyl)-5-methoxy-2-methyl-1H-indole-3-acetic Acid, 4-Methoxyphenyl Ester; Indomethacin 1-(p-Chlorobenzoyl)-5-methoxy-2-methyl-1H-indole-3-acetic Acid; Ibuprofen; Flurbiprofen (±)-2-Fluoro-a-methyl[1,1′-biphenyl]-4-acetic Acid); Diclofenac Sodium (2-[(2,6-Dichlorophenyl)amino]benzeneacetic Acid, Sodium); Diclofenac, 4′-Hydroxy-(2-[((2′,6′-Dichloro-4′-hydroxy) phenyl)amino]benzeneacetic Acid) and COX-2 Inhibitor I (Methyl [5-methylsulfonyl-1-(4-chlorobenzyl)-1H-2-indolyl]carboxylate).

As discussed above, R⁴ of a compound according to Formula I can be a conjugated targeting moiety. Any suitable targeting moiety can be used in accordance with the teachings presented herein. As used herein, a “targeting moiety” is a moiety that increases the concentration of a compound in or near a tissue, cell, etc. of interest when the molecule is introduced into a subject, relative to a compound that lacks the targeting moiety. A targeting moiety can be, for example, a cancer targeting moiety or a mitochondria targeting moiety. A targeting moiety can be conjugated to the Pt of a compound according to Formula I or to a linker that is conjugated to the Pt of a compound according to Formula I in a similar manner as described above with regard to conjugated cyclooxygenase inhibitors. A targeting moiety can be attached in a manner similar to that described in, for example, U.S. Provisional Patent Application No. 61/976,559, FILED ON Apr. 8, 2014 and entitled MITOCHONDRIA-TARGETING CISPLATIN PRODRUG, which application is hereby incorporated herein by reference to the extent that it does not conflict with the disclosure presented herein.

Any suitable cancer targeting moiety may be attached to a nanoparticle described herein. Examples of cancer targeting moieties include moieties that bind cell surface antigens or markers that are selective to cancer cells or over-expressed, up-regulated or otherwise present in amounts not found in non-cancer cells.

Any suitable mitochondria targeting moiety can be used. Examples of mitochondria targeting moieties that can be incorporated into a compound according to Formula I are described in, for example, WO 2013/033513 A1, entitled APOPTOSIS-TARGETING NANOPARTICLES and published on Mar. 7, 2013. In embodiments, a mitochondria targeting moiety is a moiety that facilitates accumulation of the nanoparticle in the mitochondrial matrix.

Any suitable moiety for facilitating accumulation of the nanoparticle within the mitochondrial matrix may be employed. Due to the substantial negative electrochemical potential maintained across the inner mitochondrial membrane, delocalized lipophilic cations are effective at crossing the hydrophobic membranes and accumulating in the mitochondrial matrix. Triphenyl phosophonium (TPP) containing moieties can be used to concentrate compounds in the mitochondrial matrix. Any suitable TPP-containing compound may be used as a mitochondrial matrix targeting moiety. Representative examples of TPP-based moieties may have structures indicated below in Formula IX, Formula X or Formula XI:

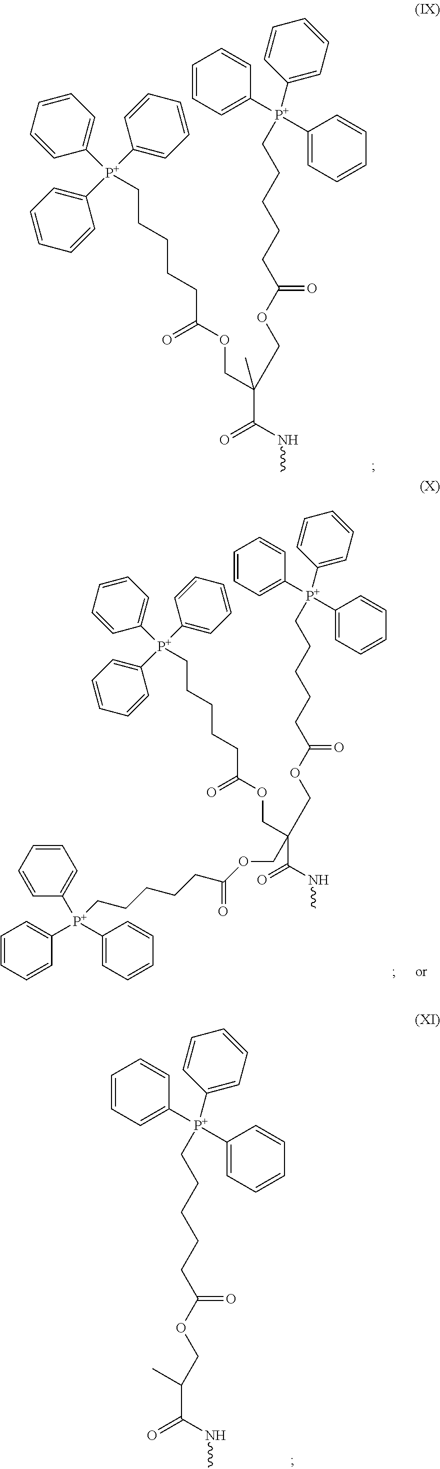

where the amine (as depicted) may be conjugated to a linker that is conjugated to the Pt(IV) of a compound according to Formula I. Of course conjugation can be accomplished via other groups of a compound according to Formula IX, X, or XI.

In some embodiments, the delocalized lipophilic cation for targeting the mitochondrial matrix is a rhodamine cation, such as Rhodamine 123 having Formula XII as depicted below:

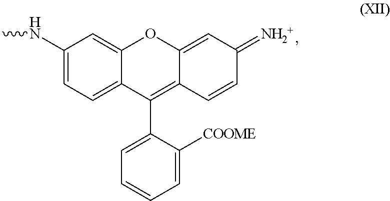

where the secondary amine (as depicted) may be conjugated to a linker that is conjugated to the Pt(IV) of a compound according to Formula I. Of course conjugation can be accomplished via another group of a compound according to Formula XII.

Of course, non-cationic compounds may serve to target and accumulate in the mitochondrial matrix. By way of example, Szeto-Shiller peptide may serve to target and accumulate a nanoparticle in the mitochondrial matrix. Any suitable Szetto-Shiller peptide may be employed as a mitochondrial matrix targeting moiety. Non-limiting examples of suitable Szeto-Shiller peptides include SS-02 and SS-31, having Formula XIII and Formula XIV, respectively, as depicted below:

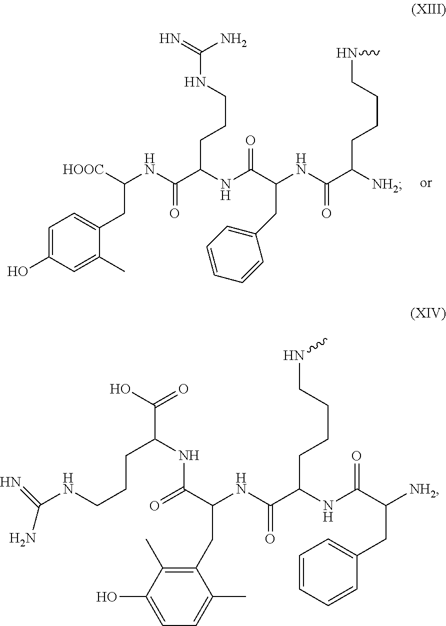

where the secondary amine (as depicted) may be conjugated to a linker that is conjugated to the Pt(IV) of a compound according to Formula I. Of course conjugation can be accomplished via other groups of a compound according to Formula XII or XIV.

A compound according to Formula I can be used for any suitable purpose. In some embodiments, a compound according to Formula I is used to treat a subject having, suffering from, or at risk of a cancer, a proliferative disease or an inflammatory disease.

“Treating a subject having a cancer” includes achieving, partially or substantially, one or more of the following: arresting the growth or spread of a cancer, reducing the extent of a cancer (e.g., reducing size of a tumor or reducing the number of affected sites), inhibiting the growth rate of a cancer, and ameliorating or improving a clinical symptom or indicator associated with a cancer (such as tissue or serum components).

Effective amounts of a compound according to Formula I can be administered to a subject to treat an inflammatory disease. Inflammatory diseases that can be treated include disorders characterized by one or both of localized and systemic inflammatory reactions, including, diseases involving the gastrointestinal tract and associated tissues (such as appendicitis, peptic, gastric and duodenal ulcers, peritonitis, pancreatitis, ulcerative, pseudomembranous, acute and ischemic colitis, inflammatory bowel disease, diverticulitis, epiglottitis, achalasia, cholangitis, coeliac disease, cholecystitis, hepatitis, Crohn's disease, enteritis, and Whipple's disease); systemic or local inflammatory diseases and conditions (such as asthma, allergy, anaphylactic shock, immune complex disease, organ ischemia, reperfusion injury, organ necrosis, hay fever, sepsis, septicemia, endotoxic shock, cachexia, hyperpyrexia, eosinophilic granuloma, granulomatosis, and sarcoidosis); diseases involving the urogential system and associated tissues (such as septic abortion, epididymitis, vaginitis, prostatitis and urethritis); diseases involving the respiratory system and associated tissues (such as bronchitis, emphysema, rhinitis, cystic fibrosis, adult respiratory distress syndrome, pneumonitis, pneumoultramicroscopicsilicovolcanoconiosis, alvealitis, bronchiolitis, pharyngitis, pleurisy, and sinusitis); diseases arising from infection by various viruses (such as influenza, respiratory syncytial virus, HIV, hepatitis B virus, hepatitis C virus and herpes), bacteria (such as disseminated bacteremia, Dengue fever), fungi (such as candidiasis) and protozoal and multicellular parasites (such as malaria, filariasis, amebiasis, and hydatid cysts); dermatological diseases and conditions of the skin (such as burns, dermatitis, dermatomyositis, sunburn, urticaria warts, and wheals); diseases involving the cardiovascular system and associated tissues (such as vasulitis, angiitis, endocarditis, arteritis, atherosclerosis, thrombophlebitis, pericarditis, myocarditis, myocardial ischemia, congestive heart failure, periarteritis nodosa, and rheumatic fever); diseases involving the central or peripheral nervous system and associated tissues (such as Alzheimer's disease, meningitis, encephalitis, multiple sclerosis, cerebral infarction, cerebral embolism, Guillame-Barre syndrome, neuritis, neuralgia, spinal cord injury, paralysis, and uveitis); diseases of the bones, joints, muscles and connective tissues (such as the various arthritides and arthralgias, osteomyelitis, fasciitis, Paget's disease, gout, periodontal disease, rheumatoid arthritis, and synovitis); other autoimmune and inflammatory disorders (such as myasthenia gravis, thryoiditis, systemic lupus erythematosus, Goodpasture's syndrome, Behcets's syndrome, allograft rejection, graft-versus-host disease, Type I diabetes, ankylosing spondylitis, Berger's disease, diabetes including Type I diabetes, ankylosing spondylitis, Berger's disease, and Retier's syndrome); nosicomal infection; and various cancers, tumors and proliferative disorders (such as Hodgkins disease).

Any suitable type of cancer can be treated by administering an effective amount of a compound according to Formula I to a subject in need thereof. Cancers that can be treated or prevented by administering an effective amount of compound according to Formula I to a subject in need thereof include, but are not limited to, human sarcomas and carcinomas, e.g., fibrosarcoma, myxosarcoma, liposarcoma, chondrosarcoma, osteogenic sarcoma, chordoma, angiosarcoma, endotheliosarcoma, lymphangiosarcoma, lymphangioendotheliosarcoma, synovioma, mesothelioma, Ewing's tumor, leiomyosarcoma, rhabdomyosarcoma, colon carcinoma, colorectal cancer, anal carcinoma, esophageal cancer, gastric cancer, hepatocellular cancer, bladder cancer, endometrial cancer, pancreatic cancer, breast cancer, ovarian cancer, prostate cancer, stomach cancer, atrial myxomas, squamous cell carcinoma, basal cell carcinoma, adenocarcinoma, sweat gland carcinoma, sebaceous gland carcinoma, thyroid and parathyroid neoplasms, papillary carcinoma, papillary adenocarcinomas, cystadenocarcinoma, medullary carcinoma, bronchogenic carcinoma, renal cell carcinoma, hepatoma, bile duct carcinoma, choriocarcinoma, seminoma, embryonal carcinoma, Wilms' tumor, cervical cancer, testicular tumor, lung carcinoma, small cell lung carcinoma, non-small-cell lung cancer, bladder carcinoma, epithelial carcinoma, glioma, pituitary neoplasms, astrocytoma, medulloblastoma, craniopharyngioma, ependymoma, pinealoma, hemangioblastoma, acoustic neuroma, schwannomas, oligodendroglioma, meningioma, spinal cord tumors, melanoma, neuroblastoma, pheochromocytoma, Types 1-3 endocrine neoplasia, retinoblastoma; leukemias, e.g., acute lymphocytic leukemia and acute myelocytic leukemia (myeloblastic, promyelocytic, myelomonocytic, monocytic and erythroleukemia); chronic leukemia (chronic myelocytic (granulocytic) leukemia and chronic lymphocytic leukemia); and polycythemia vera, lymphoma (Hodgkin's disease and non-Hodgkin's disease), multiple myeloma, Waldenstrobm's macroglobulinemia, and heavy chain disease. It is believed that a compound according to Formula I may be particularly effective in treating a subject having prostate cancer. In some embodiments, an effective amount of a compound according to Formula I is administered to a subject to treat Castration-Resistant Prostate Cancer (CRPC).

Effective amounts of a compound according to Formula I can be administered to a subject to treat a non-cancer proliferative disorder. Non-cancerous proliferative disorders include smooth muscle cell proliferation, systemic sclerosis, cirrhosis of the liver, adult respiratory distress syndrome, idiopathic cardiomyopathy, lupus erythematosus, retinopathy, e.g., diabetic retinopathy or other retinopathies, cardiac hyperplasia, reproductive system associated disorders such as benign prostatic hyperplasia and ovarian cysts, pulmonary fibrosis, endometriosis, fibromatosis, harmatomas, lymphangiomatosis, sarcoidosis, desmoid tumors and the like.

An “effective amount” is the quantity of compound in which a beneficial clinical outcome is achieved when the compound is administered to a subject. For example, when a compound according to Formula I is administered to a subject with a cancer, a “beneficial clinical outcome” includes a reduction in tumor mass, a reduction in metastasis, a reduction in the severity of the symptoms associated with the cancer or an increase in the longevity of the subject compared with the absence of the treatment.

The precise amount of compound administered to a subject will depend on the type and severity of the disease or condition and on the characteristics of the subject, such as general health, age, sex, body weight and tolerance to drugs. It may also depend on the degree, severity and type of cancer. The skilled artisan will be able to determine appropriate dosages depending on these and other factors. Effective amounts of the disclosed compounds may range between about 1 mg/mm² per day and about 10 grams/mm² per day. If co-administered with another anti-cancer agent for the treatment of cancer, an “effective amount” of the second anti-cancer agent will depend on the type of drug used. Suitable dosages are known for approved anti-cancer agents and can be adjusted by the skilled artisan according to the condition of the subject, the type of cancer being treated and the compound according to Formula I being used.

In various embodiments, a compound according to Formula I, or a tautomer, pharmaceutically acceptable salt, solvate, or clathrate thereof, can be included in a pharmaceutical composition.

The pharmaceutical composition can include the compound and a pharmaceutically acceptable carrier or diluent.

Suitable pharmaceutically acceptable carriers may contain inert ingredients that preferably do not inhibit the biological activity of a compound according to Formula I. Pharmaceutically acceptable carriers are preferably biocompatible, i.e., non-toxic, non-inflammatory, non-immunogenic and devoid of other undesired reactions upon the administration to a subject. Standard pharmaceutical formulation techniques can be employed, such as those described in Remington's Pharmaceutical Sciences, Mack Publishing Company, Easton, Pa. Formulation of the compound to be administered will vary according to the route of administration selected (e.g., solution, emulsion, capsule). Suitable pharmaceutical carriers for parenteral administration include, for example, sterile water, physiological saline, bacteriostatic saline (saline containing about 0.9% mg/ml benzyl alcohol), phosphate-buffered saline, Hank's solution, Ringer's-lactate and the like. Methods for encapsulating compositions (such as in a coating of hard gelatin or cyclodextrins) are known in the art (Baker, et al., “Controlled Release of Biological Active Agents”, John Wiley and Sons, 1986).

A compound according to Formula I can be administered by any suitable route, including, for example, orally in capsules, suspensions or tablets or by parenteral administration. Parenteral administration can include, for example, systemic administration, such as by intramuscular, intravenous, subcutaneous, or intraperitoneal injection. The compounds of the invention can also be administered orally (e.g., dietary), topically, by inhalation (e.g., intrabronchial, intranasal, oral inhalation or intranasal drops), or rectally, depending on the type of cancer to be treated.

Many new drugs are now available to be used by oncologists in treating patients with cancer. Often, tumors are more responsive to treatment when anti-cancer drugs are administered in combination to the patient than when the same drugs are administered individually and sequentially. One advantage of this approach is that the anti-cancer agents often act synergistically because the tumors cells are attacked simultaneously with agents having multiple modes of action. Thus, it is often possible to achieve more rapid reductions in tumor size by administering these drugs in combination. Another advantage of combination chemotherapy is that tumors are more likely to be eradicated completely and are less likely to develop resistance to the anti-cancer drugs being used to treat the patient.

In some embodiments, a compound according to Formula I is incorporated into a nanoparticle. Examples of nanoparticles into which a compound according to Formula I can be incorporated include nanoparticles as described in, for example, Published PCT Patent Application WO 2013/033513, entitled Apoptosis-Targeting Nanoparticles; Published PCT Patent Application WO 2013/123298, entitled Nanoparticles for Mitochondrial Trafficking of Agents; Published PCT Patent Application WO 2014/124425, entitled Generation of Functional Dendritic Cells; and Published PCT Patent Application WO 2014/169007, entitled Combination Therapeutic Nanoparticles, each of which published patent application is hereby incorporated herein in their respective entireties to the extent that they do not conflict with the disclosure presented herein. A nanoparticle can include one or more anti-cancer or anti-proliferative agent in addition to one or more compounds according to Formula I. A nanoparticle can incorporate one or more targeting moiety, such as a targeting moiety as described above.

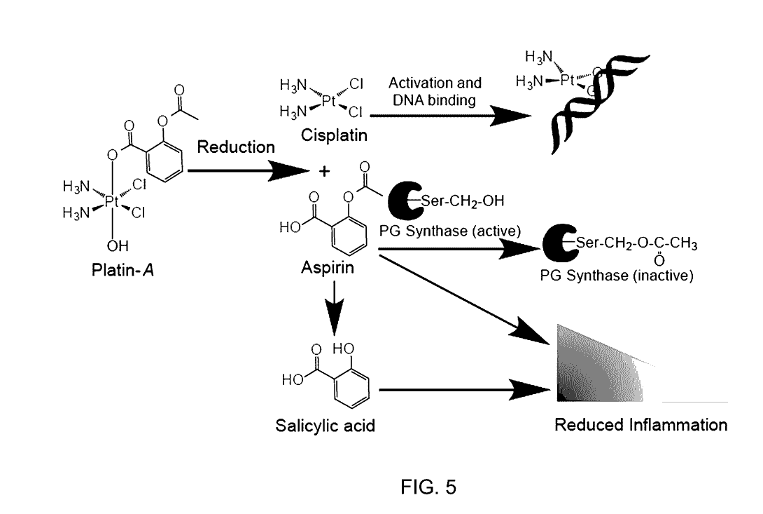

A general schematic illustrating the Pt(IV) prodrug, Platin-A (compound according to Formula VII), with the ability to release cisplatin and aspirin for their respective biological actions is shown in FIG. 5.

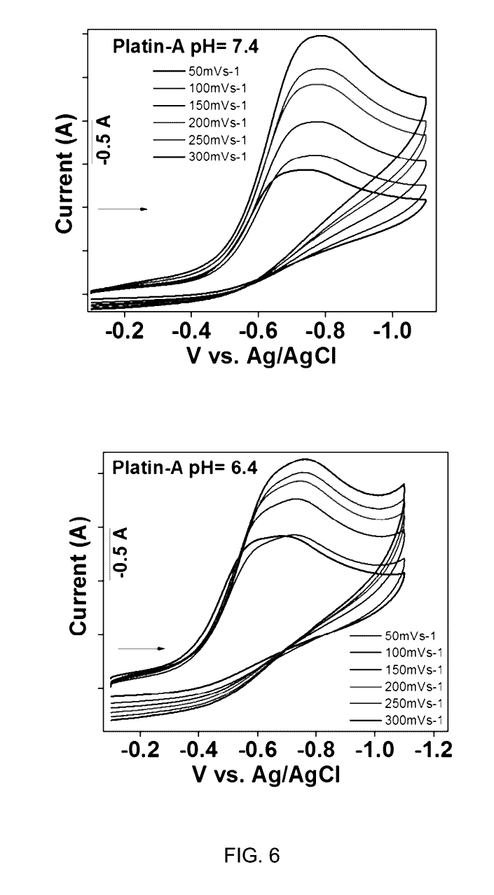

It is believed that Platin-A and other compounds according to Formula I will be reduced in a microenvironment of cancer cells, which tends to be more acidic than microenvironment of non-cancer cells. By mimicking the narrow pH range of 7.35 to 7.45 of blood, it was found that the reduction potential of Platin-A at 7.4 pH is −536 mV vs. normal hydrogen electrode (NHE) (FIG. 6). Dysregulated pH is an adaptive feature of most cancers. In normal cells, intracellular pH (pHi) is ˜7.2 which is lower than the extracellular pH (pHe) of ˜7.4. In cancer cells, pHi is >7.4 and pHe is <7.1. Reduction properties of Platin-A was studied at pH 6.4 to mimic the reduced extracellular pHe of cancer. At a pH value of 6.4, a positive shift of 42 mV was observed (FIG. 6) which indicated that the reduced pHe in cancer microenvironment would facilitate reduction of Platin-A to release cisplatin and aspirin.

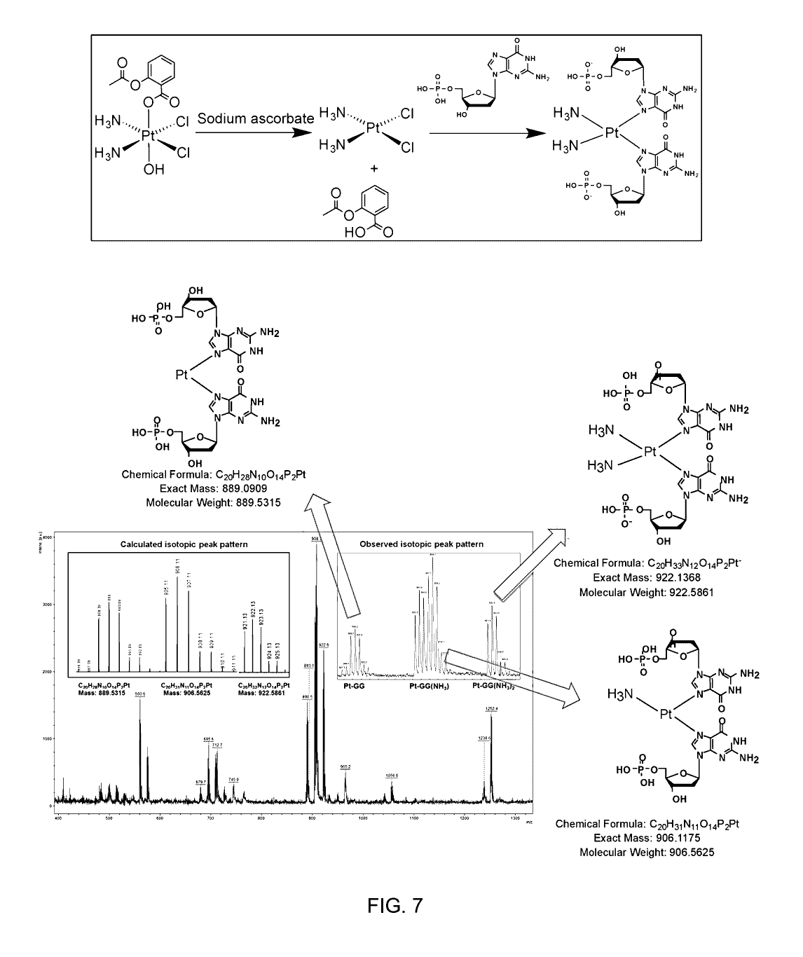

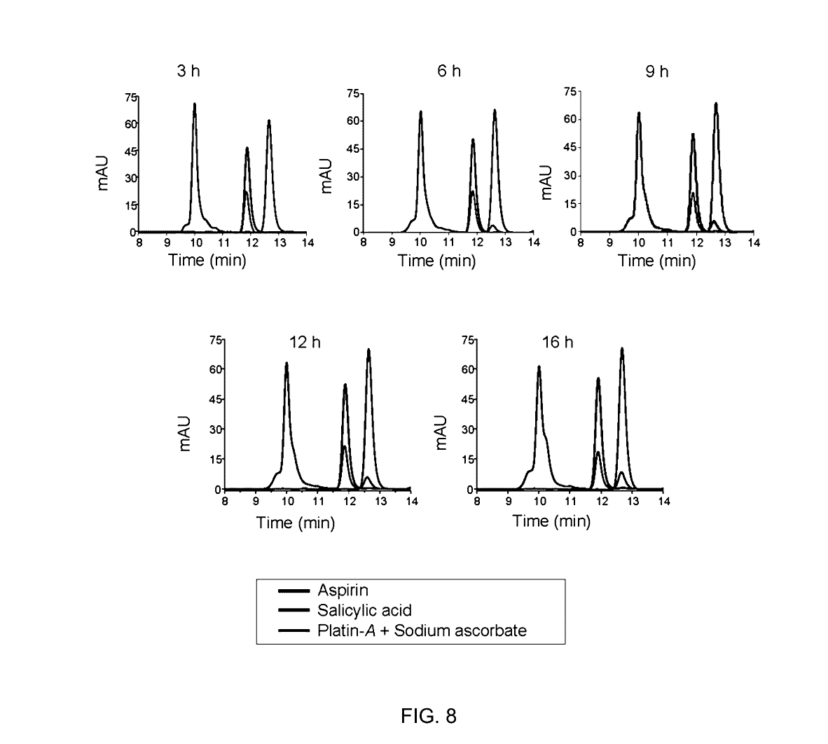

The remarkable anticancer activity of cisplatin is due to its inherent proficiency to bind with the N7 position of guanine bases leading to DNA damage. To mimic the intracellular reduction of Platin-A to cisplatin and activity of generated cisplatin with DNA, Platin-A was reduced with sodium ascorbate in the presence of 2′-deoxyguanosine 5′-monophosphate sodium salt hydrate (5′-GMP) as a truncated version of DNA, and the products were analyzed by matrix-assisted laser desorption/ionization (MALDI)-time of flight (TOF)-mass spectrometry (MS). Platin-A reduction followed by reaction with 5′-GMP showed formation of PtII-5′-GMP-bisadduct, [Pt(NH3)2(5′-GMP-N7)2](m/z=922, FIG. 7). Binding studies with 5′-GMP provided strong evidence that cisplatin released upon reduction of Platin-A will interact with nuclear DNA efficiently. The release of the other drug, aspirin from Platin-A was analyzed by HPLC (FIG. 8). HPLC chromatogram from the reduction reaction and comparison of the traces with chromatograms of pure samples of aspirin and salicylic acid indicated that Platin-A initially produces aspirin upon reduction. As time progress, formation of increasing amounts of salicylic acid, the main metabolite of aspirin was detected (FIG. 8). This observation supported the release of aspirin moiety from Platin-A in its pristine form or its final metabolite form for COX inhibitory and anti-inflammatory activities, respectively.

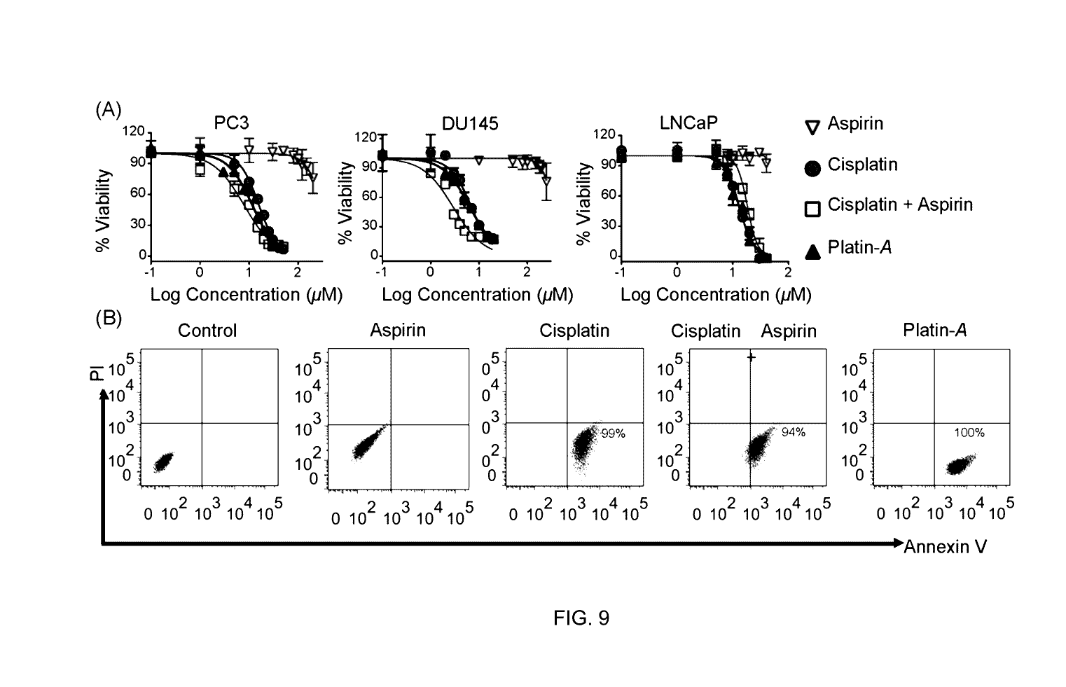

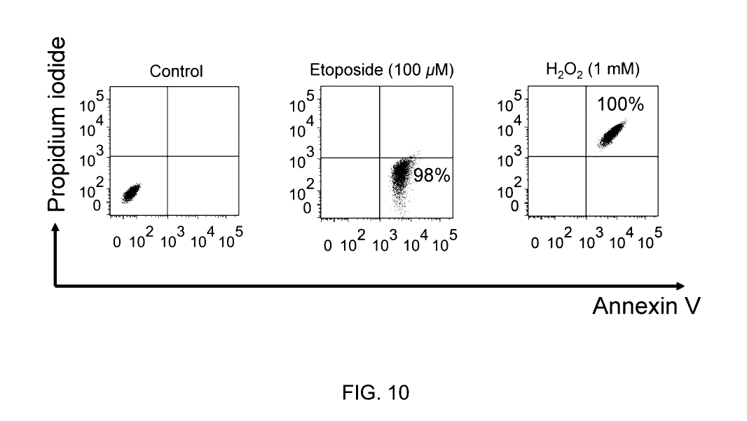

High expression of COX-2 is found in various cancers, however, for PCa cell lines as well as tissue, contradictory results exist. We therefore tested anti-proliferative properties of Platin-A on androgen-responsive LNCaP and androgenunresponsive PC3 and DU145 PCa cells that differ in their malignant potentials. Platin-A demonstrated an IC50 value comparable to that of cisplatin alone and an equimolar mixture of cisplatin and aspirin in PC3 cells (FIG. 9, Table S1 below). Similar trends were observed in DU145 and LNCaP cells for Platin-A and cisplatin (FIG. 9, Table S1). Platin-A exhibited slightly higher IC50 value than an equimolar mixture of cisplatin and aspirin in DU145. However, in LNCaP cells, Platin-A activity was better than an equimolar mixture of cisplatin and aspirin. In general, Pt(IV) compounds are less cytotoxic compared to their active Pt(II) form. Comparable cytotoxicities of Platin-A, a Pt(IV) prodrug, with cisplatin demonstrated its unique anti-proliferative potency in PCa cells. To evaluate whether Platin-A-dependent inhibition of cancer cell proliferation is associated with apoptosis, Alexa Fluor® 488 annexin V/propidium iodide (PI) staining assay was carried out in PC3 cells and the data were analyzed by fluorescence assisted cell sorting. PC3 cells (1×106 cells/mL) on day 2 were incubated with aspirin (25 μM), cisplatin (25 μM), an equimolar mixture of cisplatin and aspirin (25 μM), and Platin-A (25 μM) for 6 h. Additionally, etoposide (100 μM, 12 h) and H2O2 (1 mM, 45 min) treated cells were used as positive controls of apoptosis and necrosis, respectively (FIG. 10). High level of apoptosis was induced by Platin-A. Apoptosis inducing property of Platin-A was very similar to cisplatin and an equimolar mixture of cisplatin and aspirin. Aspirin alone did not show any changes in healthy PC3 populations under these conditions (FIG. 9B).

TABLE 1
Comparison of IC₅₀ values of cisplatin, an equimolar
mixture of cisplatin and aspirin, and Platin-A in different PCa cells

| IC50 (μM) | Platin-A | Cisplatin | Cisplatin + Aspirin |
|---|---|---|---|
| PC3 | 15 ± 5 | 14 ± 4 | 14 ± 6 |
| DU145 | 8 ± 3 | 5 ± 2 | 4 ± 1 |
| LNCaP | 12 ± 1 | 15 ± 1 | 18 ± 1 |

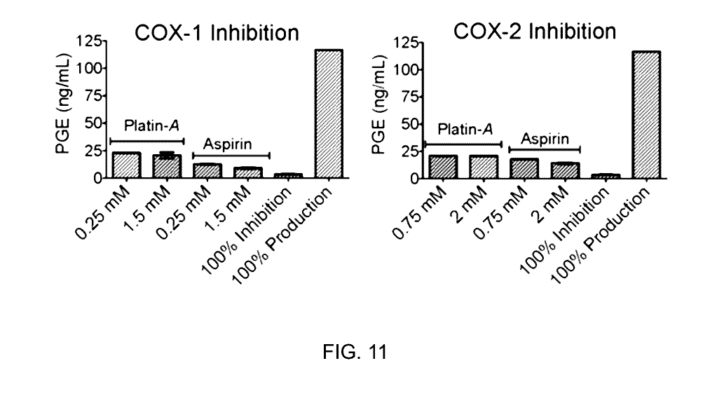

In vitro COX inhibitory properties of Platin-A were studied using an enzyme immunoassay (EIA). Aspirin was used as a positive control (FIG. 11, FIG. 12). Platin-A showed very similar inhibition of both COX-1 and COX-2 as shown by aspirin in a concentration independent manner. Aspirin is known to be more potent than salicylate as an inhibitor of COX-1 or COX-2. Comparable COX-1 and COX-2 inhibitory properties of Platin-A indicated that reduction of Platin-A first releases aspirin as supported by our HPLC analysis of Platin-A reduction by sodium ascorbate. These remarkable COX inhibitory properties of Platin-A indicated its potential in reducing tumor-associated inflammation.

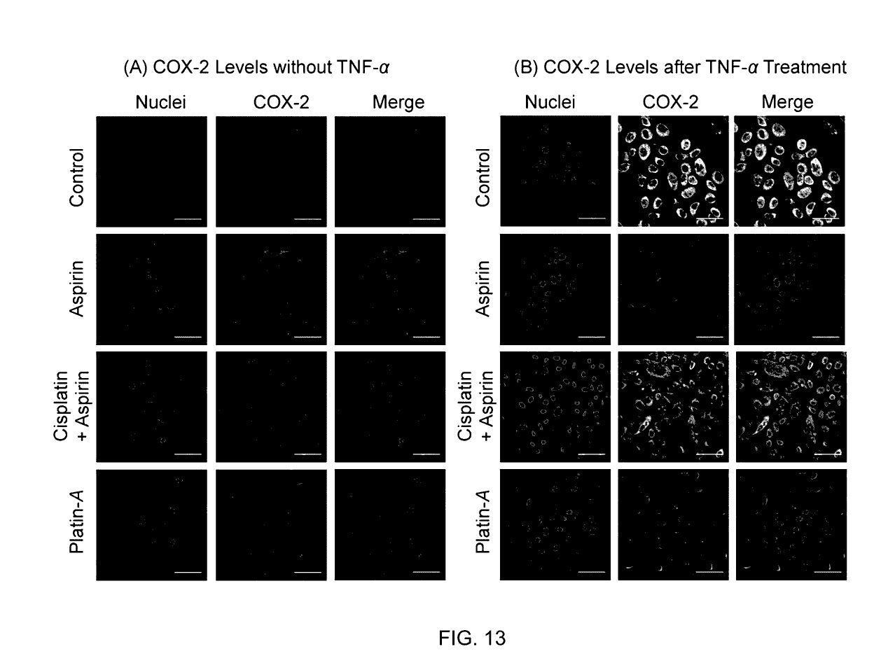

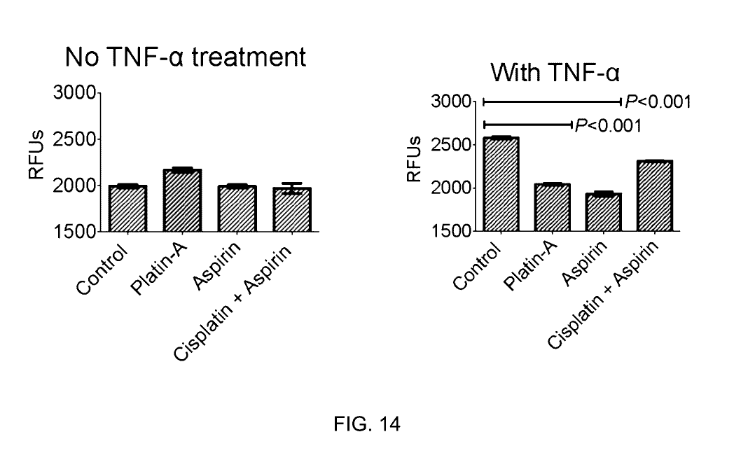

Many cancers show elevated levels of COX-2, however, COX-2 contributions to PCa and its regulation by inflammatory cytokines are controversial. Basal COX-2 levels were very low in PC3 cells and no effect was observed in the presence of all the three test articles (FIG. 13A, FIG. 14). We, therefore investigated enhancement of COX-2 levels in response to COX-2 inducing cytokine tumor necrosis factor-alpha (TNF-α) for its strong COX-2 gene expression inducing property by nuclear factor-KB (NF-κB)-binding motifs in the COX-2 promoter (FIG. 13B, FIG. 14). Treatment of PC3 cells with TNF-α (20 ng/mL) for 2 h followed by the examination of the COX-2 expression pattern upon treatment with Platin-A (1 μM), cisplatin and aspirin (1 μM), and aspirin (1 μM) for 2 h was studied. An elevated COX-2 expression was observed in TNF-α stimulated PC3 cells and the levels were reduced upon treatment with Platin-A (FIG. 13B, FIG. 14). An equimolar mixture of cisplatin and aspirin showed less prominent effect on these activated cells, and the level of inhibition shown by aspirin was similar to that observed with Platin-A (FIG. 13, FIG. 14). Significant inhibition of cellular COX-2 by Platin-A further supported its unique ability to reduce tumor-associated inflammation.

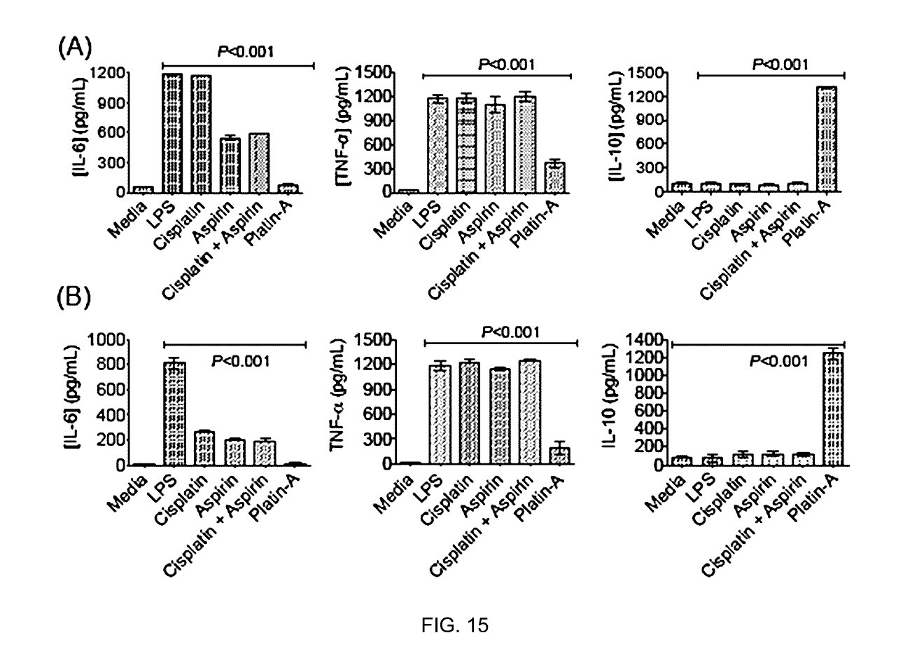

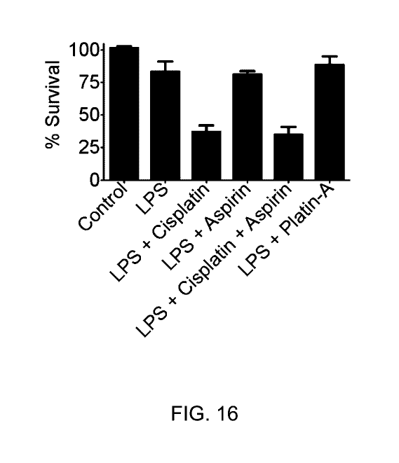

Chronic inflammation can be important for progression of human cancers, including PCa. Pro-inflammatory cytokines, TNF-α and interleukin (IL)-6, can be important for proliferation, survival, metastasis, and escape from immune surveillance of cancers. Chronic inflammation by activation of toll like receptors (TLRs) on cancer cells creates a tumor micro-environment which impairs the anti-tumor function of the immune system to allow to develop and survive. The cytokines TNF-α and IL-6 are potent activators of NF-κB, a key modulator of inflammation-induced carcinogenesis. Enhanced TNF-α secretion mediates cisplatin nephrotoxicity. The anti-inflammatory cytokine, IL-10 inhibits inflammatory and cytotoxic pathways in cisplatin-induced acute renal injury. TLR-mediated pro-inflammatory cytokine production from tumor associated macrophages (TAMs) play a key role in tumor progression, metastasis, and cancer cell metastasis. We therefore investigated the effect of Platin-A on lipopolysaccharide (LPS), an exogenous ligand for TLR4, activated RAW 264.7 macrophages to mimic the inflammatory environment in cancer. First, we evaluated the effects of Platin-A, cisplatin, a combination of cisplatin and aspirin, and aspirin on pro-inflammatory cytokines IL-6, TNF-α, and anti-inflammatory IL-10 production in LPS-stimulated RAW 264.7 macrophages. Stimulation of RAW cells with LPS markedly increased IL-6 and TNF-α production, compared with that generated under control conditions (FIG. 15A). Under our experimental conditions, we did not observe any secretion of IL-10 from RAW macrophages upon stimulation with LPS. We then tested whether Platin-A reduces the production of LPS-induced pro-inflammatory cytokines IL-6, TNF-α and possibility of induction of anti-inflammatory IL-10 using enzyme-linked immunosorbent assay (ELISA). Treatment of LPS activated macrophages with 10 μM of Platin-A for 12 h significantly reduced the levels of IL-6 and TNF-α; cisplatin under same conditions did not show any effect on the levels of these cytokines (FIG. 15A). To exclude the possibility that the decrease in the cytokines levels was simply due to the cytotoxicity of Platin-A, cell viability was evaluated. Platin-A (10 μM) did not affect cell viability (FIG. 16) when incubated for 24 h. IL-10 can inhibit the production and activity of various pro-inflammatory cytokines, these regulatory macrophages are potent inhibitors of inflammation, despite the fact that they retain the ability to produce many proinflammatory cytokines. Secretion of IL-10 by LPS activated macrophages in the presence of Platin-A indicated its unique anti-inflammatory properties.

We next assessed the effect of pretreatment of Platin-A on macrophages prior to LPS stimulation. As shown in FIG. 15B, stimulation of RAW macrophages with LPS led to a significant increase in the levels of IL-6 and TNF-α in the cell conditioned media after 12 h. Pretreatment of these macrophages with Platin-A significantly inhibited the LPS-induced IL-6 and TNF-α production at a low concentration of 10 μM. A combination of pretreatment with Platin-A and LPS showed an enhanced level of IL-10 (FIG. 15B). These results together indicated that Platin-A is efficient in curtailing inflammatory response. Pretreatment of macrophages with cisplatin, aspirin, and an equimolar mixture of cisplatin and aspirin combination did not show any preventive action against LPS stimulation.

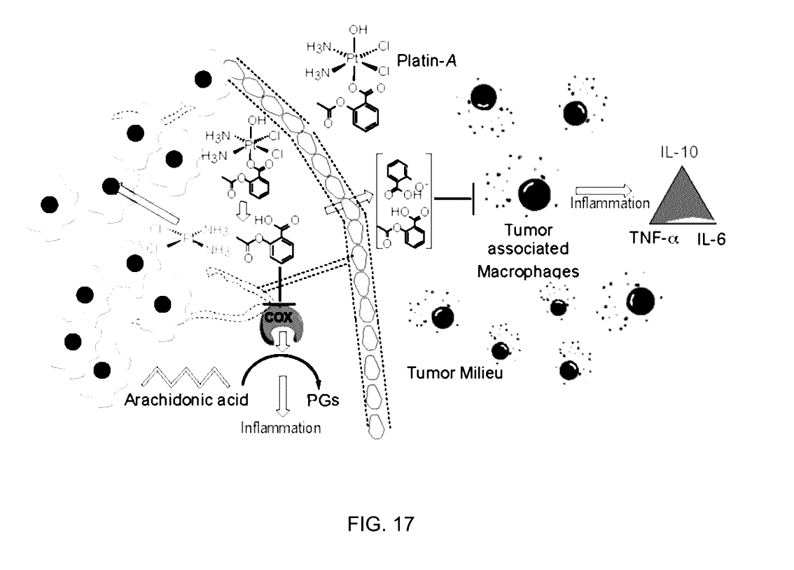

Based on our data, we sketched out a possible mechanism of action of Platin-A in FIG. 17. Platin-A is expected to reduce in the acidic and reducing tumor microenvironment to release the active drugs, cisplatin and aspirin. Active form of Pt(II) acts on the nuclear DNA as demonstrated by various techniques. Aspirin inhibits COX enzyme and along with its metabolite salicylate control the levels of inflammatory responses in TAMs as demonstrated by ELISA experiments. Platin-A exhibited unique ability to show anticancer property, inhibition of COX, and efficient anti-inflammatory profiles.

In conclusions, a unique chemo-anti-inflammatory molecule, Platin-A, a prodrug of cisplatin and aspirin was synthesized and characterized. Favorable reduction pattern of Platin-A was observed to release biologically active Pt(II) form with concurrent liberation of aspirin. Platin-A showed cytotoxicity profiles comparable to cisplatin, and demonstrated unique apoptosis inducing potency in PCa cells. Owing to its distinctive formulation bearing aspirin molecule, Platin-A showed anti-inflammatory effect with potential to reduce cisplatin related nephrotoxicity and ototoxicity. Using TNF-α as a COX-2 inducer, we were able to increase COX-2 levels in PC3 cells and observed unique ability of Platin-A to inhibit intracellular COX-2. Platin-A exhibited efficient anti-inflammatory properties in LPS induced inflamed macrophages. These results encourage further development of Platin-A as a potential candidate for cancers characterized with chronic inflammations. This work highlighted the opportunities to uniquely combine cyclooxygenase inhibitors or NSAIDs such as aspirin to cisplatin treatment regimen in the form of a single prodrug to increase efficiency and reduce side effects such as ototoxicity of chemotherapy.

All scientific and technical terms used herein have meanings commonly used in the art unless otherwise specified. The definitions provided herein are to facilitate understanding of certain terms used frequently herein and are not meant to limit the scope of the present disclosure.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise. The use of “and/or” in certain locations is not intended mean that the use of “or” in other locations cannot mean “and/or.”

As used herein, “have”, “having”, “include”, “including”, “comprise”, “comprising” or the like are used in their open ended sense, and generally mean “including, but not limited to”. It will be understood that “consisting essentially of”, “consisting of”, and the like are subsumed in “comprising” and the like.

As used herein, “disease” means a condition of a living being or one or more of its parts that impairs normal functioning. As used herein, the term disease encompasses terms such disease, disorder, condition, dysfunction and the like.

As used herein, “treat” or the like means to cure, prevent, or ameliorate one or more symptom of a disease.

As used herein, “bind,” “bound,” “conjugated” or the like means that chemical entities are joined by any suitable type of bond, such as a covalent bond, an ionic bond, a hydrogen bond, van der walls forces, or the like. “Bind,” “bound,” and the like are used interchangeable herein with “attach,” “attached,” and the like. Preferably, “conjugated” is used herein to refer to a covalent bond.

A compound as described herein may contain one or more chiral centers and/or double bonds and, therefore, exist as stereoisomers, such as double-bond isomers (i.e., geometric isomers), enantiomers, or diastereomers. For purposes of the present disclosure, chemical structures depicted herein, including a compound according to Formula I, encompass all of the corresponding compounds' enantiomers, diastereomers and geometric isomers, that is, both the stereochemically pure form (e.g., geometrically pure, enantiomerically pure, or diastereomerically pure) and isomeric mixtures (e.g., enantiomeric, diastereomeric and geometric isomeric mixtures). In some cases, one enantiomer, diastereomer or geometric isomer will possess superior activity or an improved toxicity or kinetic profile compared to other isomers. In those cases, such enantiomers, diastereomers and geometric isomers of compounds of this invention are preferred.

When a disclosed compound is named or depicted by structure, it is to be understood that solvates (e.g., hydrates) of the compound or its pharmaceutically acceptable salts are also included. “Solvates” refer to crystalline forms wherein solvent molecules are incorporated into the crystal lattice during crystallization. Solvate may include water or nonaqueous solvents such as ethanol, isopropanol, DMSO, acetic acid, ethanolamine, and EtOAc. Solvates, wherein water is the solvent molecule incorporated into the crystal lattice, are typically referred to as “hydrates”. Hydrates include a stoichiometric or non-stoichiometric amount of water bound by non-covalent intermolecular forces.

When a disclosed compound is named or depicted by structure, it is to be understood that the compound, including solvates thereof, may exist in crystalline forms, non-crystalline forms or a mixture thereof. The compounds or solvates may also exhibit polymorphism (i.e. the capacity to occur in different crystalline forms). These different crystalline forms are typically known as “polymorphs.” It is to be understood that when named or depicted by structure, the disclosed compounds and solvates (e.g., hydrates) also include all polymorphs thereof. As used herein, the term “polymorph” means solid crystalline forms of a compound or complex thereof. Different polymorphs of the same compound can exhibit different physical, chemical and/or spectroscopic properties. Different physical properties include, but are not limited to stability (e.g., to heat or light), compressibility and density (important in formulation and product manufacturing), and dissolution rates (which can affect bioavailability). Differences in stability can result from changes in chemical reactivity (e.g., differential oxidation, such that a dosage form discolors more rapidly when comprised of one polymorph than when comprised of another polymorph) or mechanical characteristics (e.g., tablets crumble on storage as a kinetically favored polymorph converts to thermodynamically more stable polymorph) or both (e.g., tablets of one polymorph are more susceptible to breakdown at high humidity). Different physical properties of polymorphs can affect their processing. For example, one polymorph might be more likely to form solvates or might be more difficult to filter or wash free of impurities than another due to, for example, the shape or size distribution of particles of it. In addition, one polymorph may spontaneously convert to another polymorph under certain conditions.

When a disclosed compound is named or depicted by structure, it is to be understood that clathrates (“inclusion compounds”) of the compound or its pharmaceutically acceptable salts, solvates or polymorphs are also included. As used herein, the term “clathrate” means a compound of the present invention or a salt thereof in the form of a crystal lattice that contains spaces (e.g., channels) that have a guest molecule (e.g., a solvent or water) trapped within.

### Experimental Section

### Materials and Instrumentations.

All chemicals were received and used without further purification unless otherwise noted. Cisplatin was purchased from Strem Chemicals, Inc. Aspirin, N, N′-dicyclohexylcarbodiimide (DCC), hydrogen peroxide solution (30 wt. % in H2O), (3-(4,5-dimethylthiazol-2-yl)-2,5-diphenyltetrazolium bromide (MTT) were purchased from Sigma-Aldrich. Interleukin (IL)-6, IL-10, and tumor necrosis factor alpha (TNF-α) cytokines were tested using BD OptEIA mouse enzyme-linked immunosorbent assay (ELISA) kits. Ultra-pure lipopolysaccharide (LPS) was purchased from Invivogen, CA, USA. Alexa Fluor® 488 annexin V/dead cell apoptosis kit was purchased from Invitrogen. COX (ovine) inhibitor screening assay kit (Cayman Chemical Item Number 560101) was procured from Cayman chemical company Ann Arbor, Mich., USA. Primary rabbit polyclonal antibody for COX-2 was procured from Abcam and Alexa Fluor® 488 goat anti-rabbit secondary antibody was purchased from Invitrogen. Human TNF-α was procured from R&D systems. K₂PtCl₄, 2′-deoxyguanosine 5′-monophosphate sodium salt hydrate (5′-GMP), and sodium ascorbate were purchased from Sigma Aldrich. KCl for electrochemistry was purchased from Sigma Aldrich.

Distilled water was purified by passage through a Millipore Milli-Q Biocel water purification system (18.2 MΩ) containing a 0.22 μm filter. 1H and 13C spectra were recorded on 400 MHz Varian NMR spectrometer and ¹⁹⁵Pt NMR spectra were recorded on a 500 MHz Varian NMR spectrometer using K₂PtCl₄ as external standard. Plate reader analyses were performed on a Bio-Tek Synergy HT microplate reader. Flow cytometry studies were performed on a BD LSRII flow cytometer equipped with digital acquisition using FACSDiva v6. Confocal images were recorded in a Nikon A1 confocal microscope. Electrospray ionization mass spectrometry (ESI-MS) and high-resolution mass spectrometry (HRMS)-ESI were recorded on Perkin Elmer SCIEX API 1 plus and Thermo scientific ORBITRAP ELITE instruments, respectively. Matrix-assisted laser desorption/ionization (MALDI)-time of flight (TOF)-mass spectrometry (MS) were carried out on a Bruker Autoflex (TOF) mass spectrometer. Electrochemical measurements were made at 25° C. on an analytical system model CHI 920c potentiostat from CH Instruments, Inc. (Austin, Tex.). FTIR spectra were collected on a Thermo-Nicolet 6700 spectrophotometer equipped with OMNIC software using samples prepared as pressed KBr pellets. High-performance liquid chromatography (HPLC) analyses were made on an Agilent 1200 series instrument equipped with a multi-wavelength UV-visible and a fluorescence detector. Cells were counted using Countess® Automated Cell Counter procured from Invitrogen life technology.

### Cell Lines and Cell Culture.

Human prostate cancer cell lines LNCaP, PC3, and DU145 and RAW 264.7 macrophages were procured from the American type culture collection (ATCC). DU145 cells were grown at 37° C. in 5% CO2 in Eagle's minimum essential medium (EMEM) supplemented with 10% fetal bovine serum (FBS) and 1% penicillin/streptomycin. LNCaP, PC3 and RAW 264.7 cells were grown in Roswell Park Memorial Institute (RPMI) 1640 medium supplemented with 10% FBS and 1% penicillin/streptomycin. Cells were passed every 3 to 4 days and restarted from frozen stocks upon reaching pass number 20.

### Synthesis of 2-Acetoxybenzoic Anhydride (Aspirin Anhydride):

A suspension of 2-acetoxybenzoic acid (5.0 g, 28 mmol) in 30 mL of CH₂Cl₂ was prepared and a solution of DCC (2.9 g, 13.9 mmol) in 10 mL of CH2Cl2 was added. The reaction mixture was stirred at room temperature for overnight. The byproduct, dicyclohexylurea (DCU), was filtered off in a glass filter and washed with a small amount of CH2Cl2. The solvent was evaporated and the resulting residue was taken up in ethyl acetate. Residual DCU was removed by filtering the resulting suspension through a glass filter. The filtrate was evaporated to give anhydride as transparent thick oil, which solidified upon storing at −20° C. Yield 4.6 g, quantitative. ¹H NMR (CDCl₃, 400 MHz): δ ppm, 8.08 (d, 2H, J=7.9 Hz), 7.70 (t, 2H, J=7.8 Hz), 7.40 (t, 2H, J=7.7 Hz), 7.19 (d, 2H, J=8.1 Hz), 2.31 (s, 6H). ¹³C NMR (CDCl₃, 100 MHz): δ 169.42, 159.29, 151.83, 135.54, 132.24, 126.29, 124.42, 121.69, 20.89. IR (KBr) νmax (cm-1): 3570 (w), 3491 (w), 3445 (w), 3332 (br), 3205 (w), 3100 (s, C—H), 2932 (s, C—H), 2855 (w), 2409 (w), 2032 (w), 1789 (br, C═O), 1728 (br, C═O), 1603 (s, C═C), 1581 (s), 1484 (s, δasCH₃), 1451 (s), 1369 (s, δsCH₃), 916 (s). 506 (s). HRMS m/z Calcd. for C₁₈H₁₄NaO₇: (M+Na)+365.0637. Found 365.0638. Melting point: 80-85° C.

### Synthesis of c,c,t-[Pt(NH₃)₂Cl₂(OH)₂]

Hydrogen peroxide (30 wt %, 60 mL) was added drop wise to a round bottom flask containing cisplatin (1.0 g, 3.33 mmol). The reaction mixture was heated to 75° C. for 5 h. The bright yellow solution was kept at room temperature in the dark for overnight to allow crystallization of the product. Yellow crystals were separated by filtration, washed with cold water and dried to get 1 g of compound. Yield 90%. IR (KBr) νmax (cm-1): 3803 (w), 3515 (w), 3458 (br, OH), 3269 (w), 1582 (s), 1442(s), 1378(s), 1074 (m, Pt—OH), 860 (br), 542 [br, Pt—N(O)]. HRMS m/z Calcd. for Cl₂H₉N₂O₂Pt: (M+H)+333.9689. Found 333.9683. Melting Point: 295-300° C.

### Synthesis of Platin-A.

A mixture of c,c,t-[Pt(NH₃)₂Cl₂(OH)₂](100 mg, 0.30 mmol) and aspirin anhydride (102.5 mg, 0.30 mmol) in 60 mL dimethysulfoxide (DMSO) was stirred for 24 h at room temperature followed by 12 h stirring at 65° C. to get a clear yellow solution. The reaction mixture was cooled to 15° C. and DMSO was removed by concentrating with multiple diethyl ether washings. The crude product was suspended in acetonitrile and precipitated with diethyl ether. This process was repeated till the final product becomes completely soluble in acetonitrile. Finally the product was isolated as a yellowish white solid by precipitating the acetonitrile solution of Platin-A by diethyl ether. Yield 17% (25 mg). 1H NMR (DMSO-d6, 400 MHz) (Figure S3): δ ppm, 7.82 (d, 1H, J=7.7 Hz), 7.47 (t, 1H, J=7.6 Hz), 7.27 (t, 1H, J=7.5 Hz), 7.06 (t, 1H, J=8.1 Hz), 6.00 (m, 6H), 2.29 (s, 3H). 13C NMR (DMSO-d6, 100 MHz) (Figure S3): δ ppm, 169.6, 149.7, 132.3, 132.0, 128.6, 125.6, 123.9, 21.8. 195Pt (DMSO-d6, 107.6 MHz) (Figure S4): 6 ppm 1020.4. HRMS m/z Calcd. for C₉H₁₅Cl₂N₂O₅Pt: (M+H+) 496.0000. Found 495.9990 (Figure S5). IR (KBr) νmax (cm-1): 3485 (br), 3226 (br), 1738 (s, C═O), 1605 (s, C═C), 1567 (m, C═C), 1482 (m, δasCH3), 1450 (m), 1339 (br, δsCH₃), 1226 (m), 1198 (s, Pt—OH), 1018 (w), 758(m), 580 [m, Pt—N(O)]. Melting Point: 110-115° C.

### Alternative Synthesis of Platin-A:

A mixture of c,c,t-[Pt(NH3)₂Cl₂(OH)₂](142 mg, 0.42 mmol) and aspirin anhydride (537 mg, 1.57 mmol) in dimethylformamide (DMF) (60 mL) was stirred for 48 h at 65° C. to get a clear yellow solution. NOTE: Aspirin anhydride was added in portions, viz., 175 mg at 0 h, 144 mg at 12 h and 218 mg at 20 h. DMF was removed by rotary evaporation. The crude product was resuspended in acetonitrile and precipitated with diethyl ether. This process was repeated till the final product becomes completely soluble in acetonitrile. Finally the product was isolated as a yellowish white solid by precipitating the acetonitrile solution of Platin-A by diethyl ether. Yield 27% (56 mg).

### Cyclic Voltammetry.

Electrochemical measurements were made at 25° C. on an analytical system model CHI 920c potentiostat from CH Instruments, Inc. (Austin, Tex.). A conventional three-electrode set-up comprising a glassy carbon working electrode, platinum wire auxiliary electrode and an Ag/AgCl (3M KCl) reference electrode was used for electrochemical measurements. The electrochemical data were uncorrected for junction potentials. KCl was used as a supporting electrolyte. Platin-A (2 mM) solutions were prepared in 20% DMF-phosphate buffered saline (PBS) of pH 6.4 and 7.4 with 0.1 mM KCl and voltammograms were recorded at different scan rates (FIG. 6).

### Pt-GG Determination:

Platin-A (1.485 mg, 0.003 mM) was dissolved in acetonitrile-water (1:2, 3 mL), 2″-deoxyguanosine 5″-monophosphate sodium salt hydrate (5′-GMP) (5.20 mg, 0.015 mM) and sodium ascorbate (2.64 mg, 0.015 mM) were added, and this mixture was incubated at 37° C. for 240 h. The deep brown solution was lyophilized. Resulting residue was dissolved in water and analyzed by MALDI-TOF-MS (FIG. 7).

Aspirin Release from Platin-A by Reversed Phase High-Performance Liquid Chromatograpy (RPHPLC):

The ability of Platin-A to release aspirin under reducing atmosphere was studied RP-HPLC. Reduction of Platin-A (2.97 mg, 2 mM) was carried out using sodium ascorbate (5.28 mg, 10 mM) in acetonitrile-water (1:2, 3 mL) and reduction product was examined by HPLC. Aspirin (2 mM) and salicylic acid (2 mM) were used as controls to match the aspirin and salicylic acid peaks in the chromatogram. A 5 μL of each solution was injected using a Zorbax C18 column and a 60:40 acetonitrile (1% trifluoroacetic acid):ammonium acetate buffer of pH 7.0 as mobile phase. The wavelength used for these experiments was 280 nm (FIG. 8).

### The (3-(4,5-dimethylthiazol-2-yl)-2,5-diphenyltetrazolium bromide or MTT Assay and Data Analysis

The cytotoxic behaviors of cisplatin, aspirin, cisplatin+aspirin, and Platin-A were evaluated using the MTT assay against PC3, DU145, LNCaP, and RAW 264.7 cells. Cells (2000 cells/well for PC3, and DU145 cells; 10000 cells/well for LNCaP and RAW 264.7) were seeded on a 96-well plate in 100 μL of desired medium and incubated for 24 h. The cells were treated with different constructs at varying concentrations and incubated for 72 h at 37° C. except for RAW 264.7 macrophages. An incubation time period of 24 h was used for macrophages. The cells were then treated with 20 μL of MTT (5 mg/mL in PBS) for 5 h. The medium was removed, the cells were lysed with 100 μL of DMSO, and the absorbance of the purple formazan was recorded at 550 nm using a Bio-Tek Synergy HT microplate reader. Each well was performed in triplicate. Cytotoxicity was expressed as mean percentage increase relative to the unexposed control+SD. Control values were set at 0% cytotoxicity or 100% cell viability. Cytotoxicity data (where appropriate) was fitted to a sigmoidal curve and a three parameters logistic model used to calculate the IC₅₀, which is the concentration of chemotherapeutics causing 50% inhibition in comparison to untreated controls. The mean IC₅₀ is the concentration of agent that reduces cell growth by 50% under the experimental conditions and is the average from at least four independent measurements that were reproducible and statistically significant. The IC₅₀ values were reported at +95% confidence intervals. This analysis was performed with GraphPad Prism (San Diego, U.S.A).

### Apoptosis Detection by Annexin V Assay.

PC3 cells were seeded at a density of 1×106 cells/mL on each well of a six well plate and allowed to grow overnight. Medium was changed and the cells were treated with 25 μM cisplatin, 25 μM aspirin, a mixture of cisplatin (25 μM) and aspirin (25 μM), and 25 μM of Platin-A for 8 h at 37° C. As positive controls, etoposide (100 μM, incubation time: 12 h) for apoptosis and H₂O₂ (1 mM, incubation time: 45 min) for necrosis were used. The cells were trypsinized, repeatedly washed, and centrifuged at 1,800 revolutions per minute (RPM) for 3 min, and the supernatants were discarded. Cell density was determined and cells were resuspended in 1× annexinVbinding buffer to 1×106 cells/mL preparing a sufficient volume to have 100 μL per assay. To 100 μL of cell suspension, 5 μL Alexa Fluor® 488 annexin V and 1 μL of 100 μg/mL propidium iodide (PI) working solution were added, incubated for 15 min at room temperature. After the incubation period, 400 μL of 1× annexin-binding buffer was added to each sample, samples were gently mixed keeping the samples on ice, and the samples were analyzed on the flow cytometer immediately.

### In Vitro COX Inhibition Assay.

An enzyme immunoassay (EIA) kit from Cayman Chemicals (catalogue number 560101) was used to assess the ability of Platin-A to inhibit ovine COX-1 and COX-2. COX inhibition assay was performed as per the manufacturer protocol. All stock solutions were prepared following manufactures instruction. This inhibition assay was carried out using a two-step process: COX reaction and EIA. COX reaction involved preparation of following samples.

(i) Background samples: COX-1 and COX-2 were inactivated by transferring 20 μL of each enzyme to an eppendorf tube and placing the tube in boiling water for 3 min. After inactivation, 970 μL of reaction buffer, 10 μL of heme, and 10 μL of inactive COX-1 or inactive COX-2 were added to test tube.
(ii) COX-1 or COX-2 100% initial activity samples: 950 μL of reaction buffer, 10 μL of heme, 10 μL of COX-1 or COX-2, and 20 μL of reaction buffer were added to each test tube.
(iii) COX-1 or COX-2 inhibitor samples: 950 μL of reaction buffer, 10 μL of heme, 10 μL of COX-1 or COX-2 and 20 μL of COX-1 and COX-2 inhibitors under investigation, aspirin and Platin-A of different concentrations (0.25, 0.5, 0.75, 1, and 1.5 mM for COX-1; 0.75, 1, 1.25, 1.5, and 2 mM for COX-2) were added to each test tube.

All the samples were incubated for 5 min in water bath at 37° C. Reactions were initiated by adding 10 μL of arachidonic acid to all samples. These samples were vortexed and incubated for another 2 min in water bath at 37° C. 50 μL of 1 M HCl was added to each test tube to stop enzyme catalysis. The test tubes were removed from water bath and 100 μL of saturated stannous chloride solution was added to each test tube and this mixture was vortexed. These samples were incubated for 5 min at room temperature. Background samples were diluted to 1:100 times, COX 100% initial activity and COX inhibitor samples were diluted to 1:2000 times.

For EIA, 100 μL of EIA buffer was added to non-specific binding well and 50 μL of EIA buffer to maximum binding wells. 50 μL of PG screening standard was added to each standard well. 50 μL of background samples were added to the background sample wells. 50 μL of COX 100% initial activity samples were added to the specific wells. 50 μL of COX inhibitor samples, aspirin and Platin-A samples were added to the specific wells. 50 μL of PG screening acetylcholinesterase (AChE) tracer was added to all the wells except the total activity and blank well. 50 μL of PG screening EIA antiserum was added to all wells except the total activity, non-specific binding, and the blank wells. EIA plate was covered with plastic film and incubated for 18 h at room temperature on an orbital shaker. Wells were emptied and rinsed 5 times with wash buffer. Ellman's reagent (200 μL) was added to each well followed by the addition of 5 μL of tracer to the total activity well. EIA plate was again covered with plastic film and then incubated for 1 h at room temperature on an orbital shaker in the dark. Absorbance was recorded at a wavelength of 410 nm using a plate reader.

### Induction of COX-2 Using Human Tumor Necrosis Factor-Alpha (TNF-α) in PC3 Cells and Immunofluorescence Analysis of COX-2 Inhibiton by Platin-A.

PC3 cells were plated at a concentration of 1×106 cells/mL on a glass coverslip and allowed to grow overnight. The cells were then grown in serum depleted media for 24 h. Human TNF-α (20 ng/mL) was then added to the cells and incubated for 2 h. Platin-A (1 μM), aspirin (1 μM), and an equimolar ratio of cisplatin and aspirin (1 μM each) was added to the cells and further incubated for another 2 h. The cells were then fixed with a 4% paraformaldehyde solution for 30 min at room temperature. The cells were then permeabilized using 1% Triton X-100 for 15 min at room temperature. The cells were blocked with a blocking buffer (1×PBS, 0.1% goat serum, 0.075% glycin) for 1 h at room temperature. The primary rabbit polyclonal antibody for COX-2 (2.5 μg/mL in blocking buffer) was added and incubation was carried out at 4° C. for 12 h. The coverslips were washed 3 times with H2O and 3 times with PBS. The cells were then incubated with the secondary AlexaFluor 488 goat anti-rabbit antibody for 1 h at 37° C. After 5 washes with blocking buffer, the cells were mounted on microscope slides with mounting media (20 mM Tris of pH 8.0, 0.5% N-propyl gallate, and 70% glycerol). Images were collected with 500 ms exposure using DAPI and FITC filters. Relative fluorescence units (RFUs) were also analyzed by a plate reader at an excitation wavelength of 488 nm and an emission of 519 nm.

### Anti-Inflammatory Properties of Platin-A by Enzyme-Linked Immunosorbent Assay (ELISA).

RAW 264.7 cells were plated at a concentration of 10,000 cells/mL in 96 plates and allowed to grow overnight. For preventative anti-inflammatory treatment, Platin-A (10 μM), aspirin (10 μM), cisplatin (10 μM) and an equimolar ratio of cisplatin and aspirin (10 μM each) was incubated with the RAW cells for 6 h. Lipopolysaccharide (LPS) (100 ng/mL) was added and the cells were further incubated for 12 h. For therapeutic anti-inflammatory treatment, LPS (100 ng/mL) was added to the RAW cells and incubated for 6 h. Platin-A (10 μM), aspirin (10 μM), cisplatin (10 μM) and an equimolar ratio of cisplatin and aspirin (10 μM each) was then added to the cells and incubated for 12 h. ELISA was performed on the supernatants against the cytokines interleukin (IL)-6, IL-10, and TNF-α. Briefly, antibody coated plates were blocked with 10% FBS in PBS for 1 h at room temperature followed by 3 washes. RAW cell supernatants were incubated on the plates for 2 h at room temperature. This was immediately followed by washings and sequential incubations with the cytokine-biotin conjugate and streptavidin working solution. Finally, the substrate reagent containing 3,3′,5,5′-tetramethylbenzidine (100 μL) was added to each well, incubated for 15 min, the reaction was stopped by adding 50 μL H2SO4 (0.1 M). The absorbance was recorded at 450 nm using a BioTek Synergy HT well plate reader.

### Synthesis of Bow Tie Compound.

A mixture of Platin-Az (0.072 g, 0.117 mmol) and Ac-[G2]-(Asp)₄ (0.503 g, 0.470 mmol) and diisopropylethylamine (DIPEA) (0.030 g, 0.235 mmol) in 10 mL dimethyformamide (DMF) was stirred for 1 h at room temperature under the purging of inert gas. CuI (0.022 g, 0.117 mmol) was added to this reaction mixture and stirring was continuing for 3 h. Solvent was removed by using rotavac. The crude product was suspended in acetonitrile and precipitated with diethyl ether. Finally product was isolated as a yellowish white solid by precipitating the acetonitrile solution by diethyl ether. 1H NMR (DMSO-d₆, 400 MHz): δ ppm, 7.85 (d, 8H), 7.66 (t, 8H), 7.34 (t, 8H), 7.22 (d, 8H), 6.53 (m, 6H), 4.38 (s, 12H), 4.16 (m, 20H), 2.20 (s, 24H), 1.78 (m, 10H), 1.45 (m, 4H), 1.23 (m, 18H), 1.308 (m, 18H). ESI-MS m/z Calcd. for C₁₂₂H₁₃₃Cl₂N₈O₄₈Pt: (M−H)⁻ 2742.7. Found 2742.4.

Thus, embodiments of PRODRUG FOR RELEASE OF CISPLATIN AND CYCLOOXYGENASE INHIBITOR are disclosed. One skilled in the art will appreciate that the nanoparticles and methods described herein can be practiced with embodiments other than those disclosed. The disclosed embodiments are presented for purposes of illustration and not limitation.

1. A Pt(IV) compound having a structure as follows: 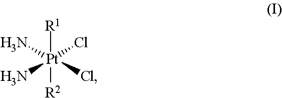
where:
R¹ is -(L¹)ₘ-(R³)ₙ;
R² is OH or -(L²)ₓ-(R⁴)_{y};
R³ is a conjugated cyclooxygenase inhibitor;
R⁴ is a conjugated cyclooxygenase inhibitor or a targeting moiety, wherein if R⁴ is a conjugated cyclooxygenase inhibitor, R³ and R⁴ are the same or different;
L¹ is a linker;
L² is a linker, wherein L¹ and L², if both are present, are the same or different;
m and x are independently zero or one; and
n and y are independently an integer greater than or equal to 1.

2. A compound according to claim 1, wherein m=0 and n=1.

3. A compound according to claim 1, wherein x=0 and y=1.

4. A compound according to claim 1, wherein m=1 and n is an integer from 1 to 4.

5. A compound according to claim 1, wherein x=1 and y is an integer from 1 to 4.

6. A compound according to claim 1, wherein R⁴ is a conjugated cyclooxygenase inhibitor.

7. A compound according to claim 1, wherein R⁴ is a conjugated aspirin.

8. A compound according to claim 1, wherein R¹ is a conjugated non-steroidal anti-inflammatory drug (NSAID).

9. A compound according to claim 1, wherein R¹ is a conjugated inhibitor of COX-1, a conjugated inhibitor of COX-2, or a conjugated inhibitor of COX-1 and COX-2.

10. A compound according to claim 1, wherein R¹ is a conjugated aspirin.

11. A compound according to claim 1, wherein R¹H is salicylic acid.

12. A compound according to claim 1, wherein reduction of the Pt(IV) to Pt(II) produces cisplatin, R¹H and R²H.

13. A compound according to claim 1, wherein the compound according to Formula I is:

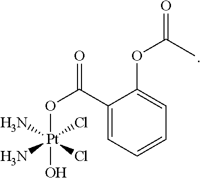

14. A compound according to claim 1, wherein the compound according to Formula I is: 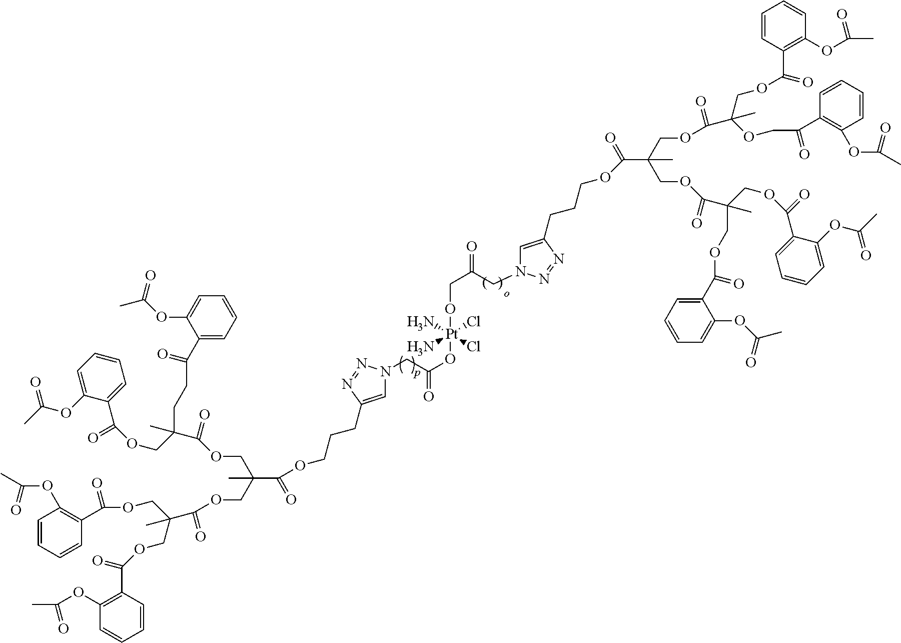
where o and p are each independently 3 to 7.

15. A compound according to claim 14, wherein o=5 and p=5.

16-20. (canceled)

21. A method comprising administering a compound according to claim 1 to a subject.

22. A method for treating a patient at risk or suffering from cancer or an inflammatory disease, comprising administering an effective amount of a compound according to claim 1 to the patient.

23. A method according to claim 22, wherein the patient is at risk or suffering from prostate cancer.

24. A method according to claim 22, wherein the patient is at risk or suffering from an inflammatory disease.
